(19) United States
(12) Patent Application Publication
(10) Pub. No.: US 2019/0003848 A1
(43) Pub. Date: Jan. 3, 2019

(54) FACILITY-INFORMATION GUIDANCE DEVICE, SERVER DEVICE, AND FACILITY-INFORMATION GUIDANCE METHOD

(71) Applicant: Mitsubishi Electric Corporation, Tokyo (JP)

(72) Inventors: Shogo HOTEN, Tokyo (JP); Masanobu OSAWA, Tokyo (JP); Atsushi MATSUMOTO, Tokyo (JP)

(73) Assignee: Mitsubishi Electric Corporation, Tokyo (JP)

(21) Appl. No.: 16/060,553

(22) PCT Filed: Feb. 5, 2016
(86) PCT No.: PCT/JP2016/053513

§ 371 Date: Jun. 8, 2018

(51) Int. Cl. G01C 21/36; G01C 21/34; G06F 17/30

(52) U.S. Cl. CPC G01C 21/3644; G06F 17/30241; G01C 21/3476; G01C 21/3438

(57) ABSTRACT

A facility-information guidance device (38) includes a facility-search request transmitter (31) for transmitting to a second server device (3) a facility-search request signal including information about an occupant of a host vehicle (1), a facility information receiver (36) for receiving from the second server device (3) facility information about a facility satisfying a search condition set up using the information included in the facility-search request signal, and an output controller (37) for performing either a control operation to cause a display device (28) to display a screen image including the facility information, or a control operation to cause a sound output device (29) to output a sound including the facility information. When a facility satisfying the search condition for a single facility exists, the facility information receiver (36) receives facility information about the single facility from the second server device (3). When a facility satisfying the search condition for a single facility does not exist and facilities satisfying the search condition for a combination of facilities exist, the facility information receiver receives facility information about the plural facilities from the second server device (3).

### TECHNICAL FIELD

The present invention relates to a facility-information guidance device that provides guidance information on facilities serving as the potential route points or destinations of a vehicle, a server device that operates in conjunction with the facility-information guidance device and thus is a part of a facility-information guidance system, and a facility-information guidance method using the facility-information guidance device.

### BACKGROUND ART

Conventionally, systems have been developed which search for facilities serving as potential destinations of vehicles in accordance with the preferences of occupants in the vehicles and present information about the facilities to users. For example, a destination presentation system disclosed in Patent Literature 1 recognizes the gender of an occupant in a vehicle to thereby estimate features of facilities for which the occupant has a preference, and presents to the occupant the facilities having the features as potential destinations. This system is intended for presenting appropriate destinations in accordance with the type of the occupant.

### CITATION LIST

### Patent Literature

Patent Literature 1: Japanese Patent Application Publication No. 2010-237134.

### SUMMARY OF INVENTION

### Technical Problem

The destination presentation system disclosed in Patent Literature 1 estimates a feature of facilities for which an individual occupant has a preference, and narrows down facilities serving as potential destinations. In that case, as a general rule, the larger the number of occupants, the lower the probability that a single facility available for all the occupants exists, due to causes such as the number of persons for which the facility is available. Therefore, the problem arises where, as a result of the narrowing-down of facilities, no facility as a potential destination is found and an appropriate destination cannot be presented.

The present invention is made in order to solve the above-mentioned problem, and it is therefore an object of the present invention to, even when no facility which satisfies a search condition for a single facility exists, provide guidance information on appropriate facilities satisfying the search condition.

### Solution to Problem

In accordance with the present invention, there is provided a facility-information guidance device which includes: a facility-search request transmitter to transmit to a server device a facility-search request signal including information about one or more occupants of one or more vehicles; a facility information receiver to receive, from the server device, facility information about a facility satisfying a search condition that is set up using the information included in the facility-search request signal; and an output controller to perform either a control operation to cause a display device to display a screen image including the facility information, or a control operation to cause a sound output device to output a sound including the facility information. When a facility which satisfies the search condition for a single facility exists, the facility information receiver receives the facility information about the single facility from the server device. When a facility which satisfies the search condition for a single facility does not exist and facilities which satisfy the search condition for a combination of plural facilities, the facility information receiver receives the facility information about the plural facilities from the server device.

### Advantageous Effects of Invention

According to the present invention, because the above-described configuration is provided, even when no facility which satisfies a search condition for a single facility exists, guidance information on appropriate facilities satisfying a search condition can be provided.

### BRIEF DESCRIPTION OF DRAWINGS

FIG. 1 is a functional block diagram showing a main part of a facility-information guidance system according to Embodiment 1 of the present invention;

FIG. 2A is an explanatory illustration showing information stored in a user information database according to Embodiment 1 of the present invention;

FIG. 2B is an explanatory illustration showing information stored in the user information database according to Embodiment 1 of the present invention;

FIG. 3 is an explanatory illustration showing information stored in a facility information database according to Embodiment 1 of the present invention;

FIG. 4 is a diagram of a hardware configuration which illustrates main parts of a terminal apparatus, a first server device, and a second server device according to Embodiment 1 of the present invention;

FIG. 5 is a flowchart showing operations of the terminal apparatus according to Embodiment 1 of the present invention;

FIG. 6 is a flowchart showing operations of the first server device according to Embodiment 1 of the present invention;

FIG. 7 is a flowchart showing other operations of the terminal apparatus according to Embodiment 1 of the present invention;

FIG. 8 is a flowchart showing operations of the second server device according to Embodiment 1 of the present invention;

FIG. 9 is a flowchart showing other operations of the terminal apparatus according to Embodiment 1 of the present invention;

FIG. 10 is an explanatory illustration showing a screen image which is displayed on a display device by the terminal apparatus according to Embodiment 1 of the present invention;

FIG. 11 is a functional block diagram showing a main part of a facility-information guidance system according to Embodiment 2 of the present invention;

FIG. 12A is an explanatory illustration showing information stored in a user information database according to Embodiment 2 of the present invention;

FIG. 12B is an explanatory illustration showing information stored in the user information database according to Embodiment 2 of the present invention;

FIG. 12C is an explanatory illustration showing information stored in the user information database according to Embodiment 2 of the present invention;

FIG. 13 is a functional block diagram showing main parts of a terminal-side invitation controller and server-side invitation controller according to Embodiment 2 of the present invention;

FIG. 14 is a flowchart showing operations of a terminal apparatus and a first server device according to Embodiment 2 of the present invention;

FIG. 15 is a flowchart showing other operations of the terminal apparatus and first server device according to Embodiment 2 of the present invention;

FIG. 16 is a flowchart showing operations of a second server device according to Embodiment 2 of the present invention;

FIG. 17 is an explanatory illustration showing a screen image which is displayed on a display device by the terminal apparatus according to Embodiment 2 of the present invention;

FIG. 18 is a functional block diagram showing a main part of a facility-information guidance system according to Embodiment 3 of the present invention;

FIG. 19 is a flowchart showing operations of a terminal apparatus according to Embodiment 3 of the present invention; and

FIG. 20 is a flowchart showing another operations of the terminal apparatus according to Embodiment 3 of the present invention.

### DESCRIPTION OF EMBODIMENTS

In order to describe this invention in further detail below, embodiments for practicing the present invention will be described with reference to the accompanying drawings.

### Embodiment 1

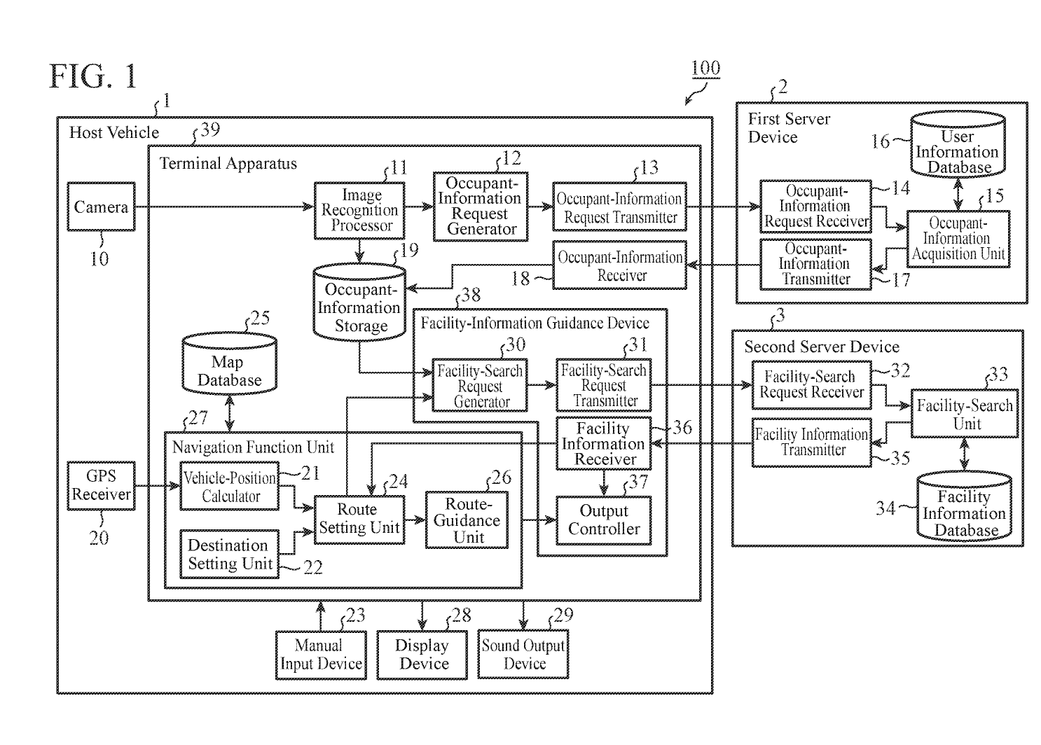

FIG. 1 is a functional block diagram showing a main part of a facility-information guidance system according to Embodiment 1 of the present invention. The facility-information guidance system 100 according to Embodiment 1 will be described with reference to FIG. 1.

A camera 10 is disposed in a host vehicle 1 and captures images of seats of the host vehicle 1 from a front side. The camera 10 is comprised of one or more cameras. The camera 10 outputs data about the captured image to an image recognition processor 11.

The image recognition processor 11 performs image recognition processing on the image data input thereto from the camera 10, to detect an image of the face of an occupant sitting on each seat of the host vehicle 1. The image recognition processor 11 outputs a result of the image recognition processing to an occupant-information request generator 12, and also causes an occupant-information storage 19 to store the detected face image. The image recognition processor 11 further causes the occupant-information storage 19 to store information (hereafter referred to as “driver information”) showing to which one of a driver and an occupant each face image corresponds.

The occupant-information request generator 12 generates a signal (hereafter referred to as an “occupant-information request signal”) for making a request to perform an operation to acquire information about each occupant of the host vehicle 1 from pieces of information stored in a user information database 16. The result of the image recognition processing provided by the image recognition processor 11 is included in the occupant-information request signal.

An occupant-information request transmitter 13 transmits the occupant-information request signal generated by the occupant-information request generator 12. An occupant-information request receiver 14 receives the occupant-information request signal transmitted by the occupant-information request transmitter 13, and outputs the occupant-information request signal to an occupant-information acquisition unit 15.

The user information database 16 stores an identifier (hereafter referred to as a “user ID”) assigned to an individual user who uses the facility-information guidance system 100, a face image of an individual user, and a piece of information (hereafter referred to as “user information”) about an individual user, which are related to one another. The user ID is constituted by, for example, a numerical value with two or more digits, or a combination of two or more components selected from among a numerical value, an alphabetic character and a symbol. In the user information about an individual user, for example, a user's hobby, a preference for facilities, a record of one or more facilities which the user used in the past are included.

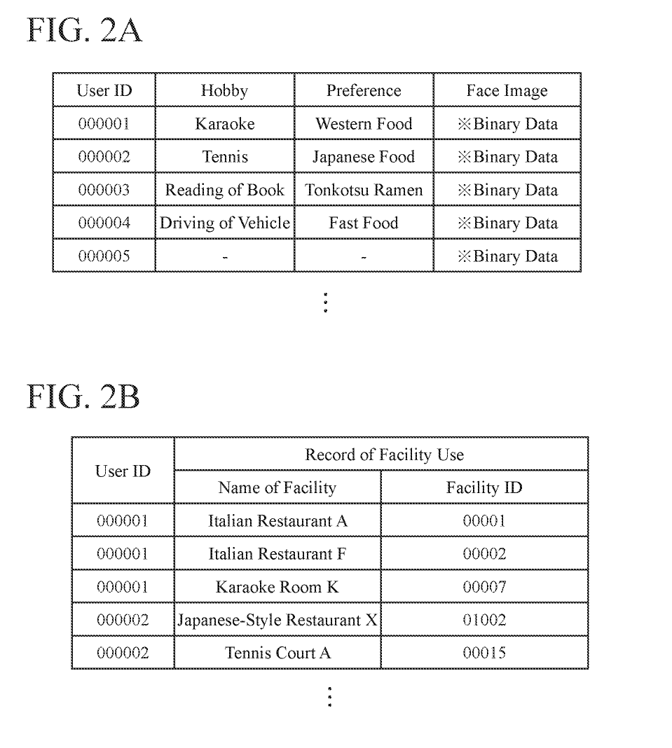

FIGS. 2A and 2B show examples of information pieces stored in the user information database 16. As shown in FIG. 2A, the user information database 16 stores a user ID, binary data corresponding to a face image, and user information indicating a hobby and a preference for facilities of a user, which are related to one another. Further, as shown in FIG. 2B, the user information database 16 stores a user ID, and user information indicating a record of one or more facilities which a corresponding user used in the past, which are related to each other.

The occupant-information acquisition unit 15 searches face images stored in the user information database 16, for a face image corresponding to the result of the image recognition processing indicated by the occupant-information request signal. When the face image is stored in the user information database 16, the occupant-information acquisition unit 15 acquires the user ID and the user information which are related to the face image, from the user information database 16, and outputs the user ID and the user information to an occupant-information transmitter 17. On the other hand, when the face image corresponding to the result of the image recognition processing indicated by the occupant-information request signal is not stored in the user information database 16, the occupant-information acquisition unit 15 assigns a new user ID to the face image indicated by the result of image recognition processing, and causes the user information database 16 to store the face image and the user ID which are related to each other.

The occupant-information transmitter 17 transmits the user ID and the user information which are input from the occupant-information acquisition unit 15. An occupant-information receiver 18 receives the user ID and the user information which are transmitted by the occupant-information transmitter 17, and causes the occupant-information storage 19 to store the user ID and the user information.

At this time, the occupant-information receiver 18 stores the user ID and the user information that are in relation to the face image and the driver information which are stored in advance in the occupant-information storage 19 by the image recognition processor 11. More specifically, the occupant-information storage 19 according to Embodiment 1 stores the face image of an occupant of the host vehicle 1, the driver information, the user ID, and the user information, which are related to one another for each occupant.

A GPS (Global Positioning System) receiver 20 is disposed in the host vehicle 1, and receives GPS signals from not-illustrated GPS satellites. A vehicle-position calculator 21 calculates the current position of the host vehicle 1 by using the GPS signals received by the GPS receiver 20 or an output signal of a not-illustrated acceleration sensor, gyro sensor, or speed sensor which is disposed in the host vehicle 1. The vehicle-position calculator 21 can calculate the current position by using a combination of the GPS signals and an output signal of one or more types of sensors, or can determine the current position by using output signals of two or more types of sensors.

A destination setting unit 22 sets up a destination of the host vehicle 1 by a manipulation input to a manual input device 23. A route setting unit 24 searches for a travel route from the current position determined by the vehicle-position calculator 21 to the destination set up by the destination setting unit 22 by using map data stored in a map database 25. Usually, plural travel routes are included in a search result provided by the route setting unit 24. The route setting unit 24 sets up a travel route (hereafter referred to as a “navigation route”) which is one of the travel routes included in the search result and which is a guidance target, by a manipulation input to the manual input device 23.

A route-guidance unit 26 generates image data used for guidance on the navigation route, and outputs the image data to an output controller 37. The route-guidance unit 26 also generates voice data used for guidance on the navigation route, and outputs the voice data to the output controller 37. A navigation function unit 27 is constituted by the vehicle-position calculator 21, the destination setting unit 22, the route setting unit 24, and the route-guidance unit 26.

The output controller 37 causes a display device 28 to display a screen image for showing the navigation route by using the image data input from the route-guidance unit 26. In addition, the output controller 37 causes the display device 28 to display various screens including various pieces of information input from the navigation function unit 27. The output controller 37 also causes a sound output device 29 to output a sound for showing the navigation route by using the voice data input from the route-guidance unit 26. In addition, the output controller 37 causes the sound output device 29 to output various sounds including the various pieces of information input from the navigation function unit 27.

The display device 28 is constituted by, for example, a liquid crystal display, an organic EL (Electro Luminescence) display, a plasma display, or a cathode-ray tube display. The sound output device 29 is constituted by, for example, a speaker, a headphone, or an earphone. The manual input device 23 is constituted by, for example, a touch panel integral with the display of the display device 28, physical buttons disposed adjacent to the display, or a microphone. The display device 28, the sound output device 29, and the manual input device 23 can be constituted separately from a terminal apparatus 39, as shown in FIG. 1, or can be constituted integrally with the terminal apparatus 39.

In this case, when searching for a travel route of the host vehicle 1, the route setting unit 24 outputs both a key word (simply referred to as a “key word” hereafter) in an operation of searching for a facility which serves as the potential route point or destination of the host vehicle 1, and positional information about a point (hereafter referred to as a “search point”) which serves as a search target point in the operation of searching for a facility to a facility-search request generator 30. The key word is input for example by a manipulation on the manual input device 23, and is comprised of one or more words that define a search condition such as “dinner” or a proper noun such as a store name. The search point is, for example, a point corresponding to the current position of the host vehicle 1, or a point set by a manipulation on the manual input device 23.

The facility-search request generator 30 generates a signal (hereafter referred to as a “facility-search request signal”) for making a request to perform the operation to search facilities whose pieces of information are stored in a facility information database 34, for a facility which serves as the potential route point or destination of the host vehicle 1. The key word, the positional information about the search point, and the one or more pieces of user information and the driver information that are stored in the occupant-information storage 19 are included in the facility-search request signal. More specifically, the facility-search request signal shows the number of occupants of the host vehicle 1 in accordance with how many pieces of user information are included in the facility-search request signal.

A facility-search request transmitter 31 transmits the facility-search request signal generated by the facility-search request generator 30. A facility-search request receiver 32 receives the facility-search request signal transmitted by the facility-search request transmitter 31, and outputs the facility-search request signal to a facility-search unit 33.

The facility information database 34 stores information about an individual facility on a facility-by-facility basis (which is hereafter referred to as “facility information”). The facility information about the individual facility includes: information indicating the name of the facility (which is hereafter referred to as “facility name information”), a unique identifier assigned to the facility (which is hereafter referred to as a “facility ID”), information indicating the position of the facility (which is hereafter referred to as “facility position information”), information indicating the phone number, categories, the opening hours, a feature of the facility, or the number of persons who can use the facility such as the number of vacant seats or the number of vacant rooms (which is hereafter referred to as “details of facility information”), and information indicating the availability of attached parking lots, occupancy or vacancy, and the available number of parking vehicles such as the number of vacant spaces (which is hereafter referred to as “information on attached parking lots”).

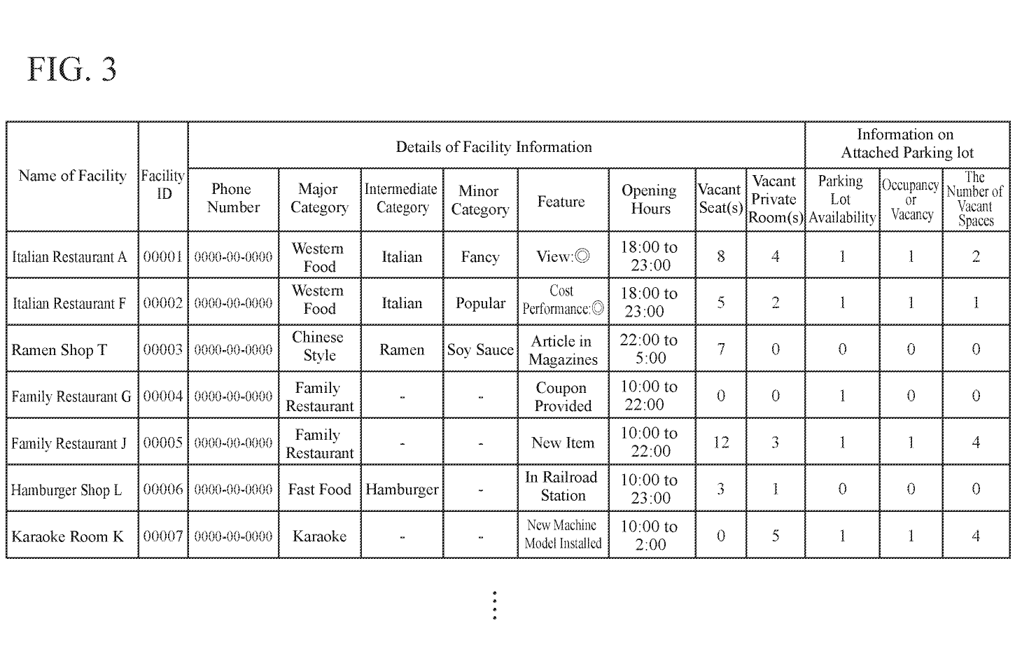

FIG. 3 shows an example of facility information pieces stored in the facility information database 34. As shown in FIG. 3, facility name information, a facility ID, details of facility information, and information on attached parking lots are included in each piece of facility information. In FIG. 3, an illustration of facility position information is omitted.

The facility-search unit 33 searches through the facilities whose pieces of facility information are stored in the facility information database 34, for a facility which serves as the potential route point or destination of the host vehicle 1. At this time, the facility-search unit 33 sets up a search condition by using the pieces of information included in the facility-search request signal. Further, when the number of occupants of the host vehicle 1 is one, the facility-search unit 33 searches for a facility which satisfies the search condition for a single facility. On the other hand, when the number of occupants of the host vehicle 1 is two or more, the facility-search unit 33 first searches for a facility which satisfies the search condition for a single facility, and, when such a single facility does not exist, then searches for plural facilities which satisfy the search condition for a combination of facilities.

In this case, plural facilities which satisfy the search condition for a combination of facilities are ones which satisfy the search condition when each occupant of the host vehicle 1 is categorized into one of plural groups, and an occupant in each of the plural groups uses a facility different from that which an occupant in any other one of the groups uses. The number of occupants included in each of the groups can be one, or two or more.

The facility-search unit 33 acquires the facility information about each facility included in the search result from the facility information database 34, and outputs the facility information to a facility information transmitter 35. At this time, when plural facilities which satisfy the search condition for a combination of facilities are included in the search result, the facility-search unit 33 outputs the pieces of facility information about the facilities in a form in which the facility information about a facility which only an occupant other than the driver of the host vehicle 1 should use is made to be subordinate to the facility information about a facility which is included in the plural facilities and which occupants including the driver of the host vehicle 1 should use. The facility-search unit 33 further generates information indicating one or more occupants who should use each of the facilities included in the search result (which is hereafter referred to as “user-occupant information”), and outputs the user-occupant information to the facility information transmitter 35.

The facility information transmitter 35 transmits the one or more pieces of facility information and the one or more pieces of user-occupant information which are input from the facility-search unit 33. A facility information receiver 36 receives the one or more pieces of facility information and the one or more pieces of user-occupant information which are transmitted by the facility information transmitter 35, and outputs the one or more pieces of facility information and the one or more pieces of user-occupant information to the route setting unit 24 and the output controller 37.

By using the one or more pieces of facility information and the one or more pieces of user-occupant information which are input from the facility information receiver 36, the route setting unit 24 searches for a travel route in which the facility indicated by the facility information is set as a route point or destination. The output controller 37 causes the display device 28 to display a screen image including the one or more pieces of facility information and the one or more pieces of user-occupant information which are input from the facility information receiver 36, and a travel route which is found by the route setting unit 24. The output controller 37 also causes the sound output device 29 to output a sound including the one or more pieces of facility information and the one or more pieces of user-occupant information which are received by the facility information receiver 36.

A facility-information guidance device 38 is constituted by the facility-search request generator 30, the facility-search request transmitter 31, the facility information receiver 36, and the output controller 37. The terminal apparatus 39 is constituted by the image recognition processor 11, the occupant-information request generator 12, the occupant-information request transmitter 13, the occupant-information receiver 18, the occupant-information storage 19, the map database 25, the navigation function unit 27, and the facility-information guidance device 38. The terminal apparatus 39 is constituted by, for example, a vehicle-mounted information terminal such as a car navigation device mounted in the host vehicle 1, or a mobile information terminal, such as a smart phone, a tablet computer, or a PND (Portable Navigation Device), which is carried into the host vehicle 1.

A first server device 2 is constituted by the occupant-information request receiver 14, the occupant-information acquisition unit 15, the user information database 16, and the occupant-information transmitter 17. The first server device 2 is constituted by, for example, a computer or the like in which an operating system for servers is installed.

A second server device 3 is constituted by the facility-search request receiver 32, the facility-search unit 33, the facility information database 34, and the facility information transmitter 35. The second server device 3 is constituted by, for example, a computer or the like in which an operating system for servers is installed.

The facility-information guidance system 100 is constituted by the terminal apparatus 39, the first server device 2, and the second server device 3.

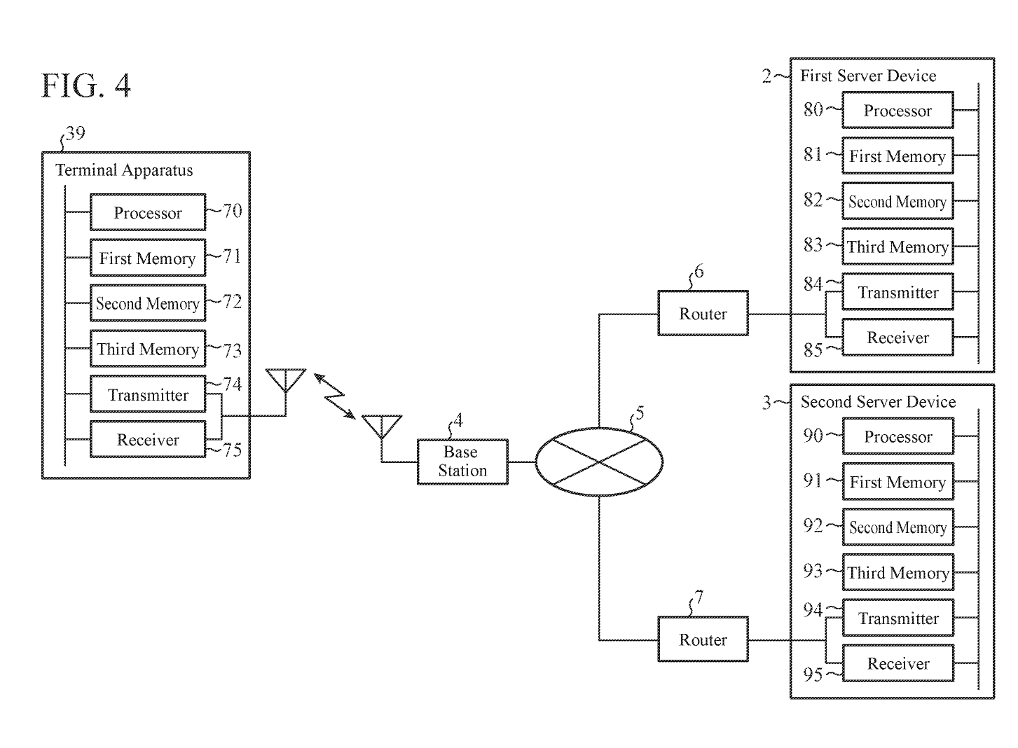

Next, the hardware configuration of the terminal apparatus 39, the first server device 2, and the second server device 3 will be described with reference to FIG. 4.

As shown in FIG. 4, the terminal apparatus 39 has a processor 70 and a first memory 71. A program for implementing the functions of the image recognition processor 11, the occupant-information request generator 12, the navigation function unit 27, the facility-search request generator 30, and the output controller 37, which are shown in FIG. 1, is stored in the first memory 71. The processor 70 reads and executes the program stored in the first memory 71, so that the functions of the image recognition processor 11, the occupant-information request generator 12, the navigation function unit 27, the facility-search request generator 30, and the output controller 37, which are shown in FIG. 1, are implemented. The processor 70 is constituted by, for example, a CPU (Central Processing Unit) or GPU (Graphics Processing Unit). The first memory 71 is constituted by, for example, a nonvolatile semiconductor memory such as a ROM (Read Only Memory).

The terminal apparatus 39 further has a second memory 72. The occupant-information storage 19 shown in FIG. 1 is implemented by the second memory 72. Further, the second memory 72 temporarily stores various data (e.g., data showing the current position and the destination of the host vehicle 1, the key word, the search point, the one or more pieces of facility information, the one or more pieces of user-occupant information, and so on) which are generated in the processing performed by the terminal apparatus 39. The second memory 72 is constituted by, for example, a volatile semiconductor memory such as a RAM (Random Access Memory).

The terminal apparatus 39 further has a third memory 73. The map database 25 shown in FIG. 1 is implemented by the third memory 73. The third memory 73 is constituted by, for example, an auxiliary storage device such as a hard disk drive or a solid state drive.

The terminal apparatus 39 further has a transmitter 74 and a receiver 75 which are used for wireless communications. The occupant-information request transmitter 13 and the facility-search request transmitter 31 which are shown in FIG. 1 are implemented by the transmitter 74, and the occupant-information receiver 18 and the facility information receiver 36 which are shown in FIG. 1 are implemented by the receiver 75. The transmitter 74 and the receiver 75 can be freely connected to the Internet 5 via a base station 4.

The first server device 2 has a processor 80 and a first memory 81. A program for implementing the function of the occupant-information acquisition unit 15 shown in FIG. 1 is stored in the first memory 81. The processor 80 reads and executes the program stored in the first memory 81, so that the function of the occupant-information acquisition unit 15 shown in FIG. 1 is implemented. The processor 80 is constituted by, for example, a CPU or GPU. The first memory 81 is constituted by, for example, a nonvolatile semiconductor memory such as a ROM.

The first server device 2 further has a second memory 82. The second memory 82 temporarily stores various data which are generated in processing performed by the first server device 2. The second memory 82 is constituted by, for example, a volatile semiconductor memory such as a RAM.

The first server device 2 further has a third memory 83. The user information database 16 shown in FIG. 1 is implemented by the third memory 83. The third memory 83 is constituted by, for example, an auxiliary storage device such as a hard disk drive or a solid state drive.

The first server device 2 further has a transmitter 84 and a receiver 85 which are used for cable communications. The occupant-information transmitter 17 shown in FIG. 1 is implemented by the transmitter 84, and the occupant-information request receiver 14 is implemented by the receiver 85. The transmitter 84 and the receiver 85 can be freely connected to the Internet 5 via a router 6.

The second server device 3 has a processor 90 and a first memory 91. A program for implementing the function of the facility-search unit 33 shown in FIG. 1 is stored in the first memory 91. The processor 90 reads and executes the program stored in the first memory 91, so that the function of the facility-search unit 33 shown in FIG. 1 is implemented. The processor 90 is constituted by, for example, a CPU or GPU. The first memory 91 is constituted by, for example, a nonvolatile semiconductor memory such as a ROM.

The second server device 3 further has a second memory 92. The second memory 92 temporarily stores various data which are generated in processing performed by the second server device 3. The second memory 92 is constituted by, for example, a volatile semiconductor memory such as a RAM.

The second server device 3 further has a third memory 93. The facility information database 34 shown in FIG. 1 is implemented by the third memory 93. The third memory 93 is constituted by, for example, an auxiliary storage device such as a hard disk drive or a solid state drive.

The second server device 3 further has a transmitter 94 and a receiver 95 which are used for cable communications. The facility information transmitter 35 shown in FIG. 1 is implemented by the transmitter 94, and the facility-search request receiver 32 is implemented by the receiver 95. The transmitter 94 and the receiver 95 can be freely connected to the Internet 5 via a router 7.

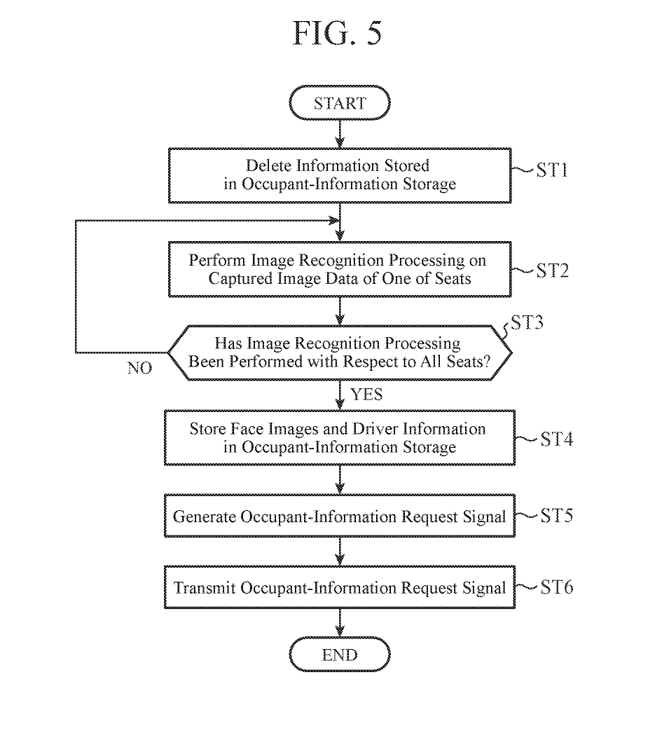

Next, the operations of the terminal apparatus 39 will be described with reference to a flowchart shown in FIG. 5, focusing on the operations of the image recognition processor 11, the occupant-information request generator 12, and the occupant-information request transmitter 13. When the power supply of the terminal apparatus 39 is switched on, and when a door of the host vehicle 1 is opened and closed in a state in which the power supply of the terminal apparatus 39 is in the on state, the terminal apparatus 39 starts an operation in step ST1.

First, in step ST1, the image recognition processor 11 deletes the pieces of information stored in the occupant-information storage 19.

Then, in step ST2, the image recognition processor 11 acquires image data which the camera 10 provides by capturing an image of one seat of the host vehicle 1, and performs image recognition processing on the image data. This image recognition processing is the one for detecting a face image included in the image data.

Then, in step ST3, the image recognition processor 11 determines whether or not the image recognition processing of step ST2 has been performed on all the seats of the host vehicle 1. When there is a seat on which the image recognition processing has not been performed (“NO” in step ST3), the image recognition processor 11 returns to step ST2.

On the other hand, when the image recognition processing has been completed on all the seats (“YES” in step ST3), the image recognition processor 11 outputs a result of the image recognition processing which is acquired every time step ST2 is performed to the occupant-information request generator 12. Further, in step ST4, the image recognition processor 11 causes the occupant-information storage 19 to store a face image which is detected every time the image recognition processing of step ST2 is performed, and also causes the occupant-information storage 19 to store the driver information.

Then, in step ST5, the occupant-information request generator 12 generates an occupant-information request signal including the result of the image recognition processing which is acquired every time step ST2 is performed, and outputs the occupant-information request signal to the occupant-information request transmitter 13. Then, in step ST6, the occupant-information request transmitter 13 transmits the occupant-information request signal input in step ST5 from the occupant-information request generator 12.

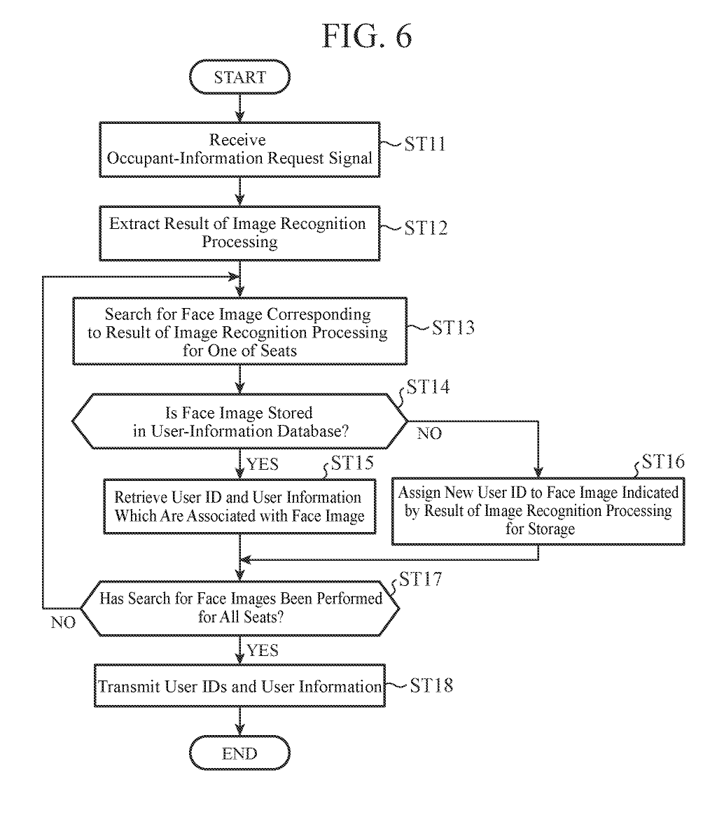

Next, the operations of the first server device 2 will be described with reference to a flowchart of FIG. 6. First, in step ST11, the occupant-information request receiver 14 receives the occupant-information request signal which the occupant-information request transmitter 13 transmits in step ST6 of FIG. 5. The occupant-information request receiver 14 outputs the received occupant-information request signal to the occupant-information acquisition unit 15.

Then, in step ST12, the occupant-information acquisition unit 15 extracts the results of the image recognition processing that is included in the occupant-information request signal input in step ST11 from the occupant-information request receiver 14.

Then, in step ST13, the occupant-information acquisition unit 15 searches through the face images stored in the user information database 16, for a face image corresponding to the result of the image recognition processing which is performed on one of the seats.

When a face image corresponding to the result of the image recognition processing is stored in the user information database 16 (“YES” in step ST14), the occupant-information acquisition unit 15, in step ST15, acquires the user ID and the user information which are in relation to the face image, from the user information database 16. On the other hand, when a face image corresponding to the result of the image recognition processing is not stored in the user information database 16 (“NO” in step ST14), the occupant-information acquisition unit 15, in step ST16, assigns a new user ID to the face image indicated by the result of the image recognition processing and causes the user information database 16 to store the face image and the user ID which are related to each other.

Following step ST15 or ST16, in step ST17, the occupant-information acquisition unit 15 determines whether or not a search for face images corresponding to the results of the image recognition processing which are acquired for all the seats has been performed. When there is a seat on which a search for a face image has not been performed (“NO” in step ST17), the occupant-information acquisition unit 15 returns to step ST13.

When searches for face images are completed for all the seats (“YES” in step ST17), the occupant-information acquisition unit 15 outputs the user ID and the user information which are acquired every time step ST16 is performed to the occupant-information transmitter 17. Then, in step ST18, the occupant-information transmitter 17 transmits the one or more user IDs and the one or more pieces of user information which are input from the occupant-information acquisition unit 15.

After step ST18, the occupant-information receiver 18 of the terminal apparatus 39 receives the one or more user IDs and the one or more pieces of user information which the occupant-information transmitter 17 transmits in step ST18. The occupant-information receiver 18 causes the occupant-information storage 19 to store the one or more user IDs and the one or more pieces of user information which are related to the face image and driver information stored in step ST4 of FIG. 5. As a result, the occupant-information storage 19 is in a state in which the face image, the driver information, the user ID, and the user information in relation to one another are stored with respect to an individual occupant of the host vehicle 1.

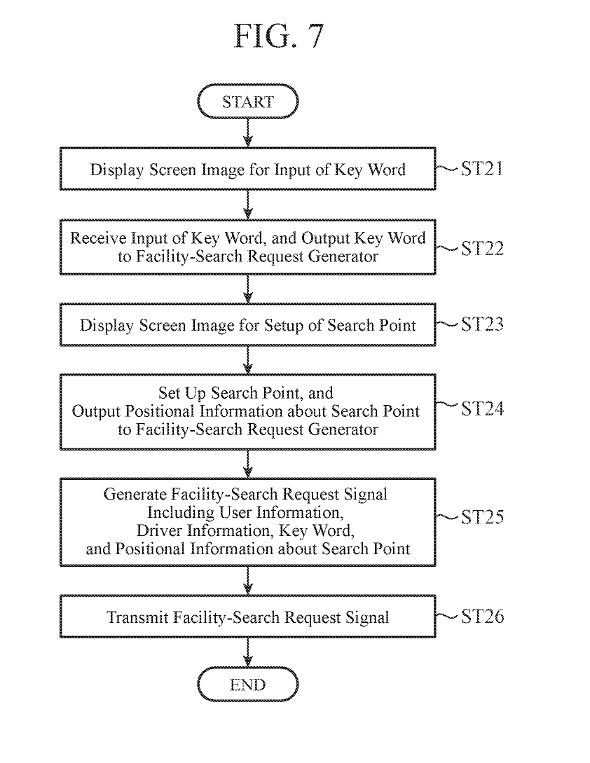

Next, the operations of the terminal apparatus 39 will be described with reference to a flowchart of FIG. 7, focusing on the operations of the route setting unit 24, the facility-search request generator 30, the facility-search request transmitter 31, and the output controller 37.

First, in step ST21, the output controller 37 causes the display device 28 to display a screen image for input of a key word.

Then, in step ST22, the route setting unit 24 receives a key word input by a manipulation on the manual input device 23. The route setting unit 24 outputs the input key word to the facility-search request generator 30.

Then, in step ST23, the output controller 37 causes the display device 28 to display a screen image for selection of a search point. This screen image for selection is, for example, the one that prompts a selection of either a “vicinity of the current position” or a “specified area.”

Then, in step ST24, the route setting unit 24 sets up a search point. For example, when a “vicinity of the current position” is selected by a manipulation on the manual input device 23, the route setting unit 24 sets, as a search point, a point corresponding to the current position calculated by the vehicle-position calculator 21. On the other hand, when a “specified area” is selected by a manipulation on the manual input device 23, the route setting unit 24 sets, as a search point, a point which a user sets up by operating the manual input device 23. The route setting unit 24 outputs the positional information about the set-up search point to the facility-search request generator 30.

Then, in step ST25, the facility-search request generator 30 generates a facility-search request signal which includes: the key word that is input in step ST22 from the route setting unit 24; the positional information that is input in step ST24 from the route setting unit 24; and the user information and driver information which are stored in the occupant-information storage 19. The facility-search request generator 30 outputs the generated facility-search request signal to the facility-search request transmitter 31.

Then, in step ST26, the facility-search request transmitter 31 transmits the facility-search request signal input in step ST25 from the facility-search request generator 30.

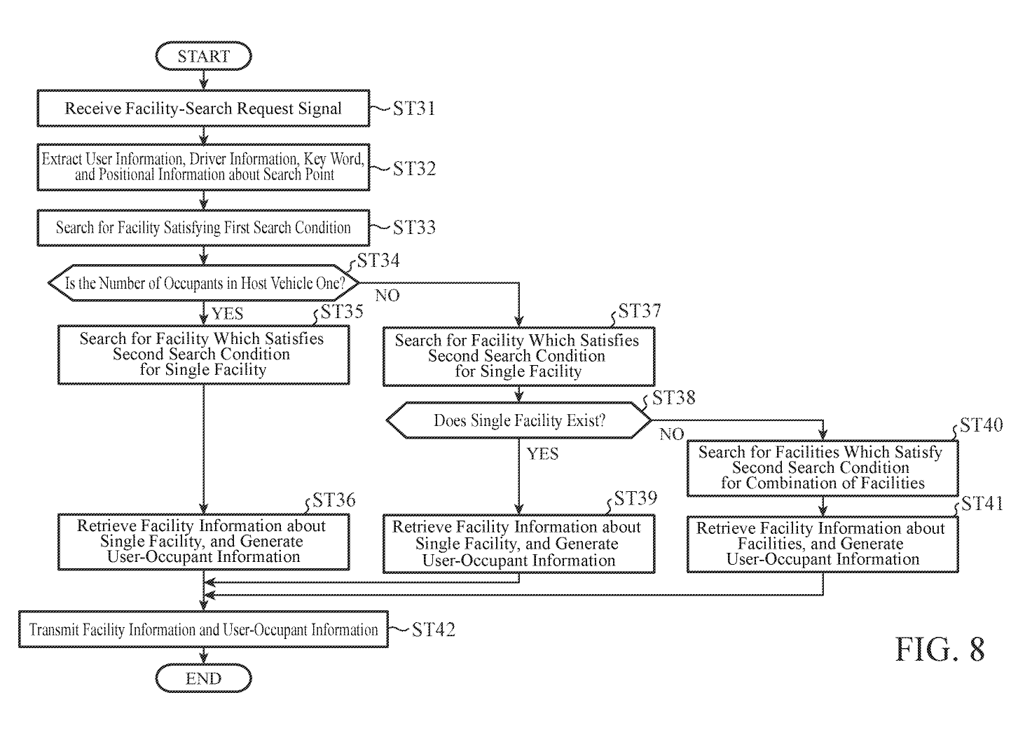

Next, the operations of the second server device 3 will be described with reference to a flowchart of FIG. 8.

First, in step ST31, the facility-search request receiver 32 receives the facility-search request signal which the facility-search request transmitter 31 transmits in step ST26 of FIG. 7. The facility-search request receiver 32 outputs the received facility-search request signal to the facility-search unit 33.

Then, in step ST32, the facility-search unit 33 extracts the one or more pieces of user information, the driver information, the key word, and the positional information about the search point which are included in the facility-search request signal input in step ST31 from the facility-search request receiver 32.

Then, in step ST33, the facility-search unit 33 sets up a search condition (hereafter referred to as a “first search condition”) which is based on the key word, the positional information about the search point, and so on which are indicated by the facility-search request signal, and searches through the facilities whose pieces of facility information are stored in the facility information database 34, for a facility satisfying the first search condition. The first search condition includes, for example, both the following conditions (1) and (2):

(1) A word corresponding to the key word is included in the details of facility information about the facility.

(2) The facility is located within a predetermined range (e.g., a range having a radius of 5 km) from the search point.

Then, in step ST34, the facility-search unit 33 determines whether or not the number of occupants of the host vehicle 1 is one. More specifically, when only the user information about one occupant is included in the facility-search request signal, the facility-search unit 33 determines that the number of occupants is one, whereas when the pieces of user information about two or more occupants are included in the facility-search request signal, the facility-search unit determines that the number of occupants is two or more.

When the number of occupants of the host vehicle 1 is one (“YES” in step ST34), the facility-search unit 33, in step ST35, sets up a search condition (hereafter referred to as a “second search condition”) which is based on the user information, the driver information, and so on which are indicated by the facility-search request signal. The facility-search unit 33 searches through the facilities included in a search result acquired in step ST33, for a facility which satisfies the second search condition for a single facility. The second search condition in step ST35 include, for example, all of the following conditions (1) to (3):

(1) The category of the facility matches a preference of an occupant who uses the facility.

(2) The facility has at least one vacant seat or room.

(3) The facility has a parking lot, and the parking lot has at least one vacant space.

Then, in step ST36, the facility-search unit 33 acquires the facility information about a facility included in a search result acquired in step ST35, namely, a facility which satisfies the second search condition for a single facility, from the facility information database 34. The facility-search unit 33 outputs the acquired facility information to the facility information transmitter 35. The facility-search unit 33 also generates user-occupant information indicating that the occupant of the host vehicle 1 should use the single facility, and outputs the user-occupant information to the facility information transmitter 35.

On the other hand, when the number of occupants of the host vehicle 1 is two or more (“NO” in step ST34), the facility-search unit 33, in step ST37, sets up a second search condition and searches through the facilities included in the search result acquired in step ST33, for a facility which satisfies the second search condition for a single facility. The second search condition in step ST37 include, for example, all of the following conditions (1) to (3):

(1) The category of the facility matches preferences of occupants who use the facility.

(2) The facility has at least vacant seats or rooms whose number is equal to the number of occupants of the host vehicle 1.

(3) The facility has a parking lot, and the parking lot has at least one vacant space.

Then, in step ST38, the facility-search unit 33 determines whether there exists a facility which satisfies the second search condition for a single facility, on the basis of a result of the search operation in step ST37.

When there exists a facility which satisfies the second search condition for a single facility (“YES” in step ST38), the facility-search unit 33, in step ST39, acquires the facility information about the facility included in a search result acquired in step ST37, namely, the facility which satisfies the second search condition for a single facility, from the facility information database 34. The facility-search unit 33 outputs the acquired facility information to the facility information transmitter 35. The facility-search unit 33 also generates user-occupant information indicating that all the occupants of the host vehicle 1 should use the single facility, and outputs the user-occupant information to the facility information transmitter 35.

On the other hand, when there does not exist a facility which satisfies the second search condition for a single facility (“NO” in step ST38), the facility-search unit 33, in step ST40, searches through the facilities included in the search result acquired in step ST33, for plural facilities which satisfy the second search condition for a combination of facilities. Here, plural facilities which satisfy the second search condition for a combination of facilities are ones which satisfy the second search condition when each occupant of the host vehicle 1 is categorized into one of plural groups, and an occupant in each of the plural groups uses a facility different from that which an occupant in any other one of the groups uses.

At this time, the facility-search unit 33 makes a combination of plural facilities in such a way that the plural facilities satisfy, for example, all of the following conditions (1) to (4):

(1) An upper limit on the number of facilities to be combined is equal to the number of occupants of the host vehicle 1.

(2) At least a facility which the driver of the host vehicle 1 uses, among the facilities to be combined, has a parking lot, and the parking lot has at least one vacant space.

(3) The distances among the facilities to be combined fall within a predetermined reference range. Concretely, for example, the straight-line distances among the facilities are equal to or shorter than 500 meters, or the distances of routes among the facilities are the ones along each of which the host vehicle 1 can travel in ten minutes or less.

(4) A combination of a smaller number of facilities is made in such a way that the second search condition is satisfied. For example, when there exist only two facilities which satisfy the second search condition for a combination of two facilities, a search for three or more facilities which satisfy the second search condition for a combination of three or more facilities is not performed.

Then, in step ST41, the facility-search unit 33 acquires the facility information about each of the facilities included in a search result acquired in step ST40, namely, each of the plural facilities which satisfy the second search condition for a combination of facilities, from the facility information database 34. The facility-search unit 33 outputs the acquired facility information to the facility information transmitter 35. At this time, the facility-search unit 33 outputs the pieces of facility information about the plural facilities in a form in which the facility information about a facility which only an occupant other than the driver of the host vehicle 1 should use is made to be subordinate to the facility information about a facility which is included in the plural facilities and which occupants including the driver of the host vehicle 1 should use. The facility-search unit 33 also generates pieces of user-occupant information each showing an occupant who should use a corresponding one of the plural facilities, and outputs the pieces of user-occupant information to the facility information transmitter 35.

Following step ST36, ST39, or ST41, the facility information transmitter 35, in step ST42, transmits the one or more pieces of facility information and the one or more pieces of user-occupant information which are input in step ST36, ST39, or ST41 from the facility-search unit 33.

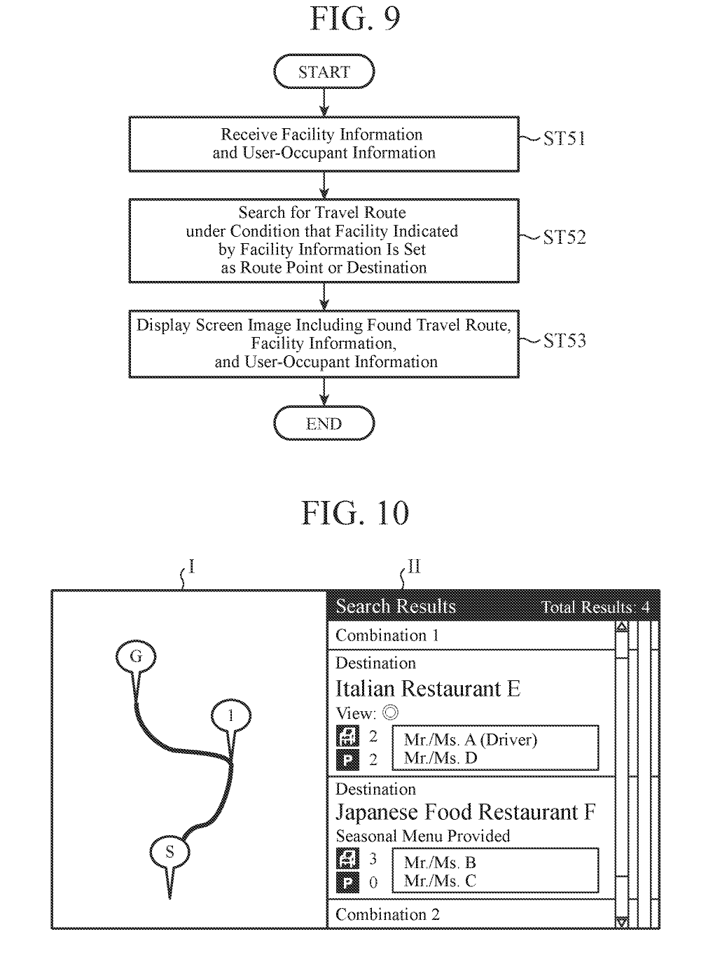

Next, the operations of the terminal apparatus 39 will be described with reference to a flowchart of FIG. 9, focusing on the operations of the facility information receiver 36, the route setting unit 24, and the output controller 37.

First, in step ST51, the facility information receiver 36 receives the facility information and user-occupant information which the facility information transmitter 35 transmits in step ST42 of FIG. 8. The facility information receiver 36 outputs the received facility information and user-occupant information to the route setting unit 24 and the output controller 37.

Then, in step ST52, the route setting unit 24 searches for a travel route in which the facility indicated by each facility information input in step ST51 from the facility information receiver 36 is set as a route point or destination.

More specifically, when the facility information about a facility which satisfies the search condition for a single facility is input, the route setting unit 24 searches for a travel route in which the single facility is set as a destination. On the other hand, when the pieces of facility information about plural facilities which satisfy the search condition for a combination of facilities are input, the route setting unit 24 searches for a travel route in which one of the plural facilities is set as a destination and each remaining facility is set as a route point. At this time, it is preferable to set, as a destination, a facility which occupants including the driver of the host vehicle 1 should use, and set, as a route point, a facility which only an occupant other than the driver of the host vehicle 1 should use.

Then, in step ST53, the output controller 37 causes the display device 28 to display a screen image including both the one or more pieces of facility information and the one or more pieces of user-occupant information which are input in step ST51 from the facility information receiver 36, and the travel route which the route setting unit 24 finds in step ST52.

An example of the screen image which the display device 28 displays in step ST52 is shown in FIG. 10. FIG. 10 shows an example of a case in which a combination of two facilities: “Italian restaurant E” and “Japanese food restaurant F” satisfies the search condition in a state in which the driver A and three passengers B to D are in the host vehicle 1.

As shown in FIG. 10, the travel route found by the route setting unit 24 is displayed in a display area I occupying a left half part of the screen. This travel route is the one in which “Italian restaurant E” which is the facility which the driver A and the passenger D of the host vehicle 1 should use is set as a destination, and “Japanese food restaurant F” which is the facility which the passengers B and C should use is set as a route point. More specifically, when plural facilities which satisfy the search condition a combination of facilities are found, the facility-search unit 33 outputs the pieces of facility information about the plural facilities in a form in which the facility information about a facility which only an occupant other than the driver of the host vehicle 1 should use is made to be subordinate to the facility information about a facility which occupants including the driver of the host vehicle 1 should use. As a result, the route setting unit 24 can distinguish the facility which the driver of the host vehicle 1 should use from each remaining facility, and search for a travel route in which the former facility is set as a destination and the latter facility is set as a route point.

Further, in a display area II occupying a right half part of the screen, the user-occupant information and facility information about “Italian restaurant E” which indicates a destination, and the user-occupant information and facility information about “Japanese food restaurant F” which is a route point are displayed. As an example of the facility information piece, the name of a facility, a feature, the number of vacant seats, and the number of vacant spaces in an attached parking lot are displayed. As a result, the information about each facility which is set as a route point or destination, and an occupant who should use each facility can be informed visually and intelligibly.

Usually, plural travel routes are included in the search result provided by the route setting unit 24. The display device 28 is configured so as to switch among plural screens respectively including the plural travel routes by a manipulation input to the manual input device 23. At this time, the route setting unit 24 can calculate the travel distance of each of the travel routes and the display device 28 can display each of the screens in such away as to switch among the screens in ascending or descending order of the travel distance.

Further, each user information which the user information database 16 stores should just be information about a user of the facility-information guidance system 100, and is not limited to the contents illustrated as examples in FIGS. 2A and 2B. For example, each user information can be one showing, in addition to the contents illustrated as examples in FIGS. 2A and 2B, the user's gender, age, address or whereabouts, the presence or absence and an update record of a driver's license, a record of traffic accidents which the user caused in the past, and so on. Among these pieces of information, as to pieces of information other than the user ID and the face image, the pieces of information input to the manual input device 23 by the user can be transmitted to the first server device 2 by the terminal apparatus 39, or the pieces of information can be acquired from a not-illustrated third server device for personal information management by the first server device 2.

Further, the second search condition should just include conditions corresponding to the descriptions of the pieces of user information about the occupants of the host vehicle 1, the pieces of user information being stored in the occupant-information storage 19, and is not limited to the above-mentioned example.

Further, the map database 25 and the navigation function unit 27 can be disposed in, instead of the terminal apparatus 39, the second server device 3 or a not-illustrated fourth server device.

As described above, the facility-information guidance device 38 according to Embodiment 1 includes: the facility-search request transmitter 31 that transmits a facility-search request signal including information about an occupant of a vehicle (host vehicle 1) to the server device (second server device 3); the facility information receiver 36 that receives the facility information about a facility satisfying a search condition from the server device (second server device 3), the search condition being set up using the information included in the facility-search request signal; and the output controller 37 that performs either a control operation to cause the display device 28 to display a screen image including the facility information, or a control operation to cause the sound output device 29 to output a sound including the facility information, and, when there exists a facility which satisfies the search condition for a single facility, the facility information receiver 36 receives the facility information about the single facility from the server device (second server device 3), whereas when there does not exist a facility which satisfies the search condition for a single facility, but there exist plural facilities which satisfy the search condition for a combination of facilities, the facility information receiver receives the pieces of facility information about the plural facilities from the server device (second server device 3). As a result, even when there does not exist a facility which satisfies the search condition for a single facility, guidance on pieces of information about appropriate facilities satisfying the search condition can be provided.

Further, the plural facilities are the ones which satisfy the search condition when each occupant of the vehicle (host vehicle 1) is categorized into one of plural groups, and an occupant in each of the plural groups uses a facility different from that which an occupant in any other one of the groups uses. As a result, even when there does not exist a facility which satisfies the second search condition for a single facility because the condition about the number of persons which can use the facility with respect to the number of occupants of the vehicle, namely, the condition (2) of the second search condition, or the like is not satisfied, guidance on pieces of information about appropriate facilities satisfying the search condition can be provided.

Further, the server device (second server device 3) according to Embodiment 1 includes: the facility-search request receiver 32 that receives the facility-search request signal including the information about an occupant of the vehicle (host vehicle 1) from the terminal apparatus 39 mounted in or carried into the vehicle (host vehicle 1); the facility-search unit 33 that sets up a search condition by using the information included in the facility-search request signal, and that searches the facilities whose facility information is stored in the facility information database 34, for a facility satisfying the search condition; and the facility information transmitter 35 that transmits the facility information about a facility included in a search result provided by the facility-search unit 33 to the terminal apparatus 39, and, when there exists a facility which satisfies the search condition for a single facility, the facility-search unit 33 sets the facility information about the single facility into the search result, whereas when there does not exist a facility which satisfies the search condition for a single facility, but there exist plural facilities which satisfy the search condition for a combination of facilities, the facility-search unit sets facility information about the plural facilities into the search result. This second server device 3 operates in conjunction with the terminal apparatus 39 having the facility-information guidance device 38, so that the facility-information guidance system 100 can be implemented.

### Embodiment 2

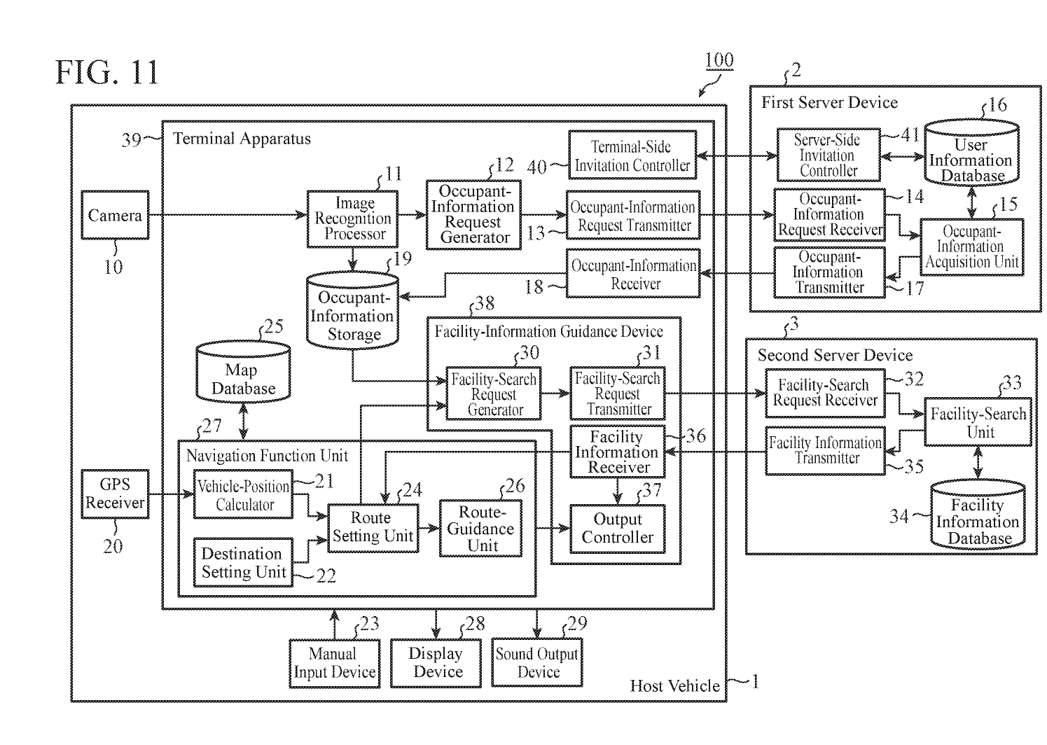

FIG. 11 is a functional block diagram showing a main part of a facility-information guidance system according to Embodiment 2 of the present invention. The facility-information guidance system 100 according to Embodiment 2 will be described with reference to FIG. 11. In FIG. 11, the same blocks as those of the facility-information guidance system 100 according to Embodiment 1 shown in FIG. 1 are denoted by the same reference numerals, and an explanation of the blocks will be omitted hereafter.

At least one vehicle (hereafter referred to as “another vehicle”) other than a host vehicle 1 has the same terminal apparatus 39 as that of the host vehicle 1. In FIG. 11, an illustration of another vehicle is omitted. Hereafter, the host vehicle 1 and another vehicle may be generically and simply referred to as the “vehicles.” The facility-information guidance system 100 is constituted by the terminal apparatuses 39 which the vehicles have, a first server device 2, and a second server device 3. Because the terminal apparatus 39 which another vehicle has is constituted in the same way that the terminal apparatus 39 which the host vehicle 1 has is constituted, an illustration and an explanation of the terminal apparatus 39 which another vehicle has will be omitted hereafter.

A unique identifier (hereafter referred to as a “vehicle ID”) is assigned to an individual vehicle. The vehicle ID is constituted by, for example, a number having two or more digits, or a combination of two or more of a number, an alphabetic character, and a symbol. Further, a unique identifier (hereafter referred to as a “vehicle group ID”) is assigned to each vehicle group (simply referred to as a “vehicle group” hereafter) which includes at least one vehicle. The vehicle group ID is constituted by, for example, a numerical value with two or more digits, or a combination of two or more of components selected from among a numerical value, an alphabetic character and a symbol.

A user information database 16 stores a user ID, a face image and user information which are the same as those of Embodiment 1, and in addition stores a vehicle ID of the vehicle in which a corresponding user is, in relation to the user ID, the face image, and the user information. Also, the user information database 16 stores a vehicle ID of the vehicle, a vehicle group ID of a vehicle group including the vehicle, and information indicating whether an invitation of the vehicle to the vehicle group exists, and indicating a vehicle ID of another vehicle which has invited the vehicle to the vehicle group (which is hereafter referred to as “invitation information”), which are related to one another. The user information database 16 further stores information about a driver of an individual vehicle.

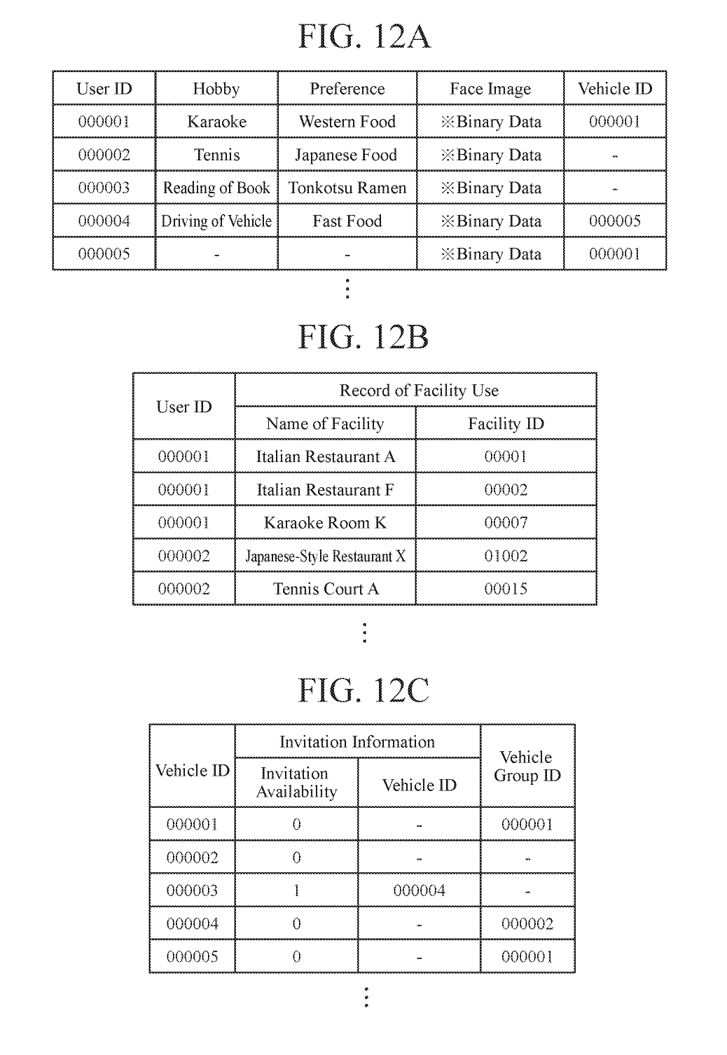

FIGS. 12A, 12B and 12C show examples of information pieces stored in the user information database 16. As shown in FIG. 12A, the user information database 16 stores the user ID of an individual user, a piece of binary data corresponding to a face image, a piece of user information indicating the user's hobby and preference for facilities, and a vehicle ID of a vehicle in which the user is, which are related to one another. Further, as shown in FIG. 12B, the user information database 16 stores the user ID of an individual user, and a piece of user information indicating a record of one or more facilities which the user used in the past, which are related to each other. In addition, as shown in FIG. 12C, the user information database 16 stores the vehicle ID of an individual vehicle, invitation information about an invitation of the vehicle, and a vehicle group ID of a vehicle group including the vehicle, which are in relation to one another. In FIGS. 12A, 12B and 12C, an illustration of the driver information about an individual vehicle is omitted.

An occupant-information request generator 12 generates an occupant-information request signal for making a request to perform an operation to acquire information about each occupant of each vehicle included in the vehicle group (hereafter referred to as the “host vehicle group”) which consists of at least one vehicle including the host vehicle 1, from the pieces of information stored in the user information database 16. In the occupant-information request signal, the vehicle ID of the host vehicle 1 and the driver information about the host vehicle are included in addition to results of image recognition processing performed by an image recognition processor 11.

An occupant-information acquisition unit 15 searches through the face images stored in the user information database 16, for a face image corresponding to the result of the image recognition processing indicated by the occupant-information request signal, like that according to Embodiment 1. When the face image is stored in the user information database 16, the occupant-information acquisition unit 15 acquires the user ID and the user information which are related to the face image from the user information database 16, and outputs the user ID and the user information to an occupant-information transmitter 17. On the other hand, when a face image corresponding to the result of the image recognition processing indicated by the occupant-information request signal is not stored in the user information database 16, the occupant-information acquisition unit 15 assigns a new user ID to the face image indicated by the result of image recognition processing, and causes the user information database 16 to store the face image, the user ID, the vehicle ID of the host vehicle 1, and the driver information, which are related to one another.

In addition, when the vehicle group ID of the vehicle group including the vehicle ID indicated by the occupant-information request signal, namely, the vehicle group ID of the host vehicle group is stored in the user information database 16, the occupant-information acquisition unit 15 acquires the vehicle ID of another vehicle included in the host vehicle group, the face image and the user ID of each user in another vehicle, and the user information about the user, and the driver information about another vehicle from the user information database 16, and outputs the vehicle ID, the face image, the user ID, the user information, and the driver information to the occupant-information transmitter 17.

The occupant-information transmitter 17 transmits the various pieces of information input from the occupant-information acquisition unit 15. An occupant-information receiver 18 receives the various pieces of information transmitted by the occupant-information transmitter 17, and causes an occupant-information storage 19 to store the various pieces of information.

In that case, the occupant-information receiver 18 stores the user ID of an individual occupant of the host vehicle 1 and the user information about the occupant, which are in relation to the vehicle ID of the host vehicle 1 and the face image and driver information stored in advance in the occupant-information storage 19 by the image recognition processor 11. Further, the occupant-information receiver 18 stores the face image and the user ID of an individual occupant of another vehicle, the user information about the occupant, and the driver information about another vehicle, while associating the face image, the user ID, the user information, and the driver information with the vehicle ID of another vehicle. More specifically, the occupant-information storage 19 according to Embodiment 2 stores the face image and the user ID of an occupant of each vehicle included in the host vehicle group, the user information about the occupant, the driver information, and the vehicle ID for each occupant, while associating the face image, the user ID, the user information, the driver information, and the vehicle ID with one another.

A facility-search request generator 30 generates a facility-search request signal for making a request to perform an operation to search the facilities whose pieces of information are stored in a facility information database 34, for a facility which serves as the potential route point or destination of each vehicle included in the host vehicle group. In the facility-search request signal, a key word, the positional information about a search point, and the one or more pieces of user information, the one or more pieces of driver information, and the one or more vehicle IDs which are stored in the occupant-information storage 19 are included.

More specifically, the facility-search request signal shows the number of vehicles included in the host vehicle group by showing how many vehicle IDs are included therein. Further, the facility-search request signal shows the total number of occupants of the host vehicle group by showing how many user IDs are included therein. In addition, the facility-search request signal shows the number of occupants of each vehicle included in the host vehicle group by showing how many user IDs are associated with the vehicle ID of the vehicle.

A facility-search unit 33 searches through the facilities whose pieces of facility information are stored in the facility information database 34, for a facility which serves as the potential route point or destination of each vehicle included in the host vehicle group. At this time, the facility-search unit 33 sets up a search condition by using the pieces of information included in the facility-search request signal.

Here, when the total number of occupants of the host vehicle group is one, the facility-search unit 33 searches for a facility which satisfies the search condition for a single facility.

On the other hand, when the total number of occupants of the host vehicle group is two or more, and the number of vehicles included in the host vehicle group is one (i.e., only the host vehicle 1 is included), the facility-search unit 33 first searches for a facility which satisfies the search condition for a single facility, and, when such a single facility does not exist, then searches for plural facilities which satisfy the search condition for a combination of facilities. In this case, plural facilities which satisfy the search condition for a combination of facilities are ones which satisfy the search condition when each occupant of the host vehicle 1 is categorized into one of plural groups, and an occupant in each of the plural groups uses a facility different from that which an occupant in any other one of the groups uses. The number of occupants included in each of the groups can be one, or two or more.

In addition, when the total number of occupants of the host vehicle group is two or more and the number of vehicles included in the host vehicle group is two or more, the facility-search unit 33 first searches for a facility which satisfies the search condition for a single facility, and, when such a single facility does not exist, searches for plural facilities which satisfy the search condition for a combination of facilities. In this case, plural facilities which satisfy the search condition for a combination of facilities are ones which satisfy the search condition when each vehicle in the host vehicle group is categorized into one of plural groups or each occupant of the host vehicle group is categorized into one of plural groups, and an occupant in each of the plural groups uses a facility different from that which an occupant in any other one of the groups uses. The number of vehicles included in each of the groups can be one, or two or more, and the number of occupants included in each of the groups can be one, or two or more.

The facility-search unit 33 acquires the facility information about each facility included in a search result from the facility information database 34, and outputs the facility information to a facility information transmitter 35. The facility-search unit 33 also generates user-occupant information indicating an occupant who should use each facility included in the search result, and outputs the user-occupant information to the facility information transmitter 35.

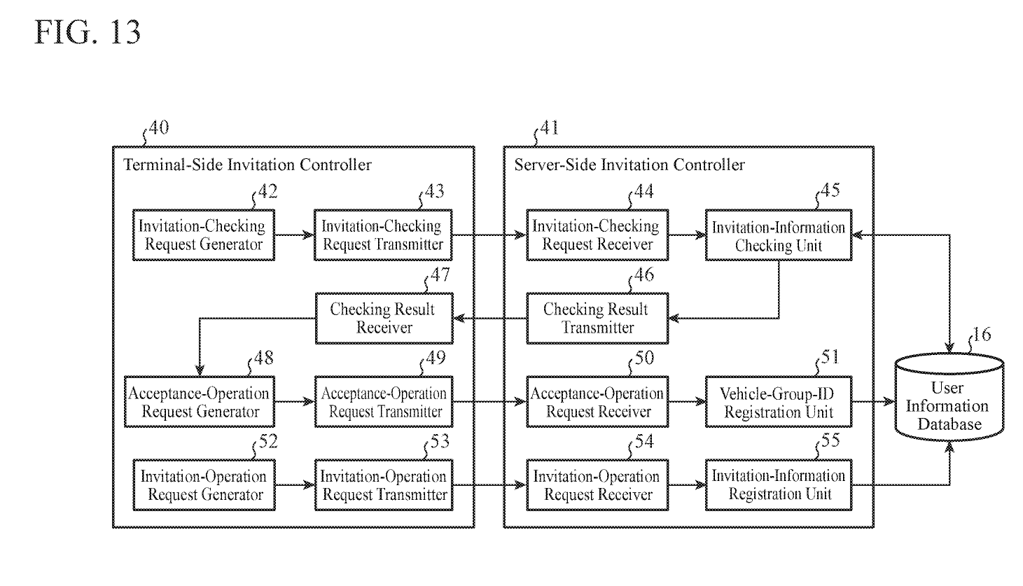

In this case, in the facility-information guidance system 100 according to Embodiment 2, each terminal apparatus 39 has a terminal-side invitation controller 40. Further, the first server device 2 has a server-side invitation control unit 41. Hereafter, the terminal-side invitation controller 40 and the server-side invitation control unit 41 will be described with reference to FIG. 13.

An invitation-checking request generator 42 generates a signal (hereafter referred to as an “invitation-checking request signal”) for making a request to perform an operation to check whether or not information about an invitation for the host vehicle 1 is stored in the user information database 16. The vehicle ID of the host vehicle 1 is included in the invitation-checking request signal.

An invitation-checking request transmitter 43 transmits the invitation-checking request signal generated by the invitation-checking request generator 42. An invitation-checking request receiver 44 receives the invitation-checking request signal transmitted by the invitation-checking request transmitter 43, and outputs the invitation-checking request signal to an invitation-information checking unit 45.

The invitation information checking unit 45 checks whether or not information about an invitation for the host vehicle 1 is stored in the user information database 16, and outputs a result of the check to a checking result transmitter 46. When information about an invitation for the host vehicle 1 is stored in the user information database 16, the vehicle ID of another vehicle which has invited the host vehicle 1 is included in the checking result. On the other hand, when no information about an invitation for the host vehicle 1 is stored in the user information database 16, the checking result shows that no invitation information is stored.

The checking result transmitter 46 transmits the checking result input from the invitation information checking unit 45. A checking result receiver 47 receives the checking result transmitted by the checking result transmitter 46, and outputs the checking result to an acceptance-operation request generator 48.

When the vehicle ID of another vehicle is included in the checking result input from the checking result receiver 47 and the manual input device 23 receives a manipulation's input indicating another vehicle's acceptance of an invitation to a vehicle group, the acceptance-operation request generator 48 generates a signal (hereafter referred to as an “acceptance-operation request signal”) for making a request to perform an operation to store the vehicle group ID of the vehicle group while associating the vehicle group ID with the vehicle ID of the host vehicle 1 in the user information database 16. The vehicle ID of the host vehicle 1 and the vehicle ID of another vehicle indicated by the checking result are included in the acceptance-operation request signal.

On the other hand, when the vehicle ID of another vehicle is included in the checking result input from the checking result receiver 47 and the manual input device 23 receives a manipulation's input indicating another vehicle's refusal of an invitation to a vehicle group, the acceptance-operation request generator 48 generates a signal (hereafter referred to as a “refusal-operation request signal”) showing that the invitation is refused. The vehicle ID of the host vehicle 1 and the vehicle ID of another vehicle indicated by the checking result are included in the refusal-operation request signal.

An acceptance-operation request transmitter 49 transmits either the acceptance-operation request signal or the refusal-operation request signal which is generated by the acceptance-operation request generator 48. An acceptance-operation request receiver 50 receives either the acceptance-operation request signal or the refusal-operation request signal which is transmitted by the acceptance-operation request transmitter 49, and outputs either the acceptance-operation request signal or the refusal-operation request signal to a vehicle-group-ID registration unit 51.

When the acceptance-operation request receiver 50 receives the acceptance-operation request signal, the vehicle-group-ID registration unit 51 stores the vehicle group ID of the vehicle group including another vehicle indicated by the acceptance-operation request signal while associating the vehicle group ID with the vehicle ID of the host vehicle 1 in the user information database 16. When no vehicle group ID is assigned to the vehicle group including another vehicle, the vehicle-group-ID registration unit 51 assigns a new vehicle group ID to the vehicle group and causes the user information database 16 to store the new vehicle group ID.

On the other hand, when the acceptance-operation request receiver 50 receives the refusal-operation request signal, the vehicle-group-ID registration unit 51 deletes the invitation information about the invitation which is provided for the host vehicle 1 by another vehicle indicated by the refusal-operation request signal, from the user information database 16.

When the manual input device 23 receives a manipulation's input indicating that another vehicle is invited to the host vehicle group, an invitation-operation request generator 52 generates a signal (hereafter referred to as an “invitation-operation request signal”) for making a request to perform a process of causing the user information database 16 to store information about the invitation which is provided for another vehicle by the host vehicle 1. The vehicle ID of the host vehicle 1 and the vehicle ID of another vehicle which is invited are included in the invitation-operation request signal.

An invitation-operation request transmitter 53 transmits the invitation-operation request signal generated by the invitation-operation request generator 52. An invitation-operation request receiver 54 receives the invitation-operation request signal transmitted by the invitation-operation request transmitter 53, and outputs the invitation-operation request signal to an invitation-information registration unit 55. The invitation-information registration unit 55 causes the user information database 16 to store the information about the invitation which is provided for another vehicle by the host vehicle 1, the invitation information being indicated by the invitation-operation request signal.

The terminal-side invitation controller 40 is constituted by the invitation-checking request generator 42, the invitation-checking request transmitter 43, the checking result receiver 47, the acceptance-operation request generator 48, the acceptance-operation request transmitter 49, the invitation-operation request generator 52, and the invitation-operation request transmitter 53. An output controller 37 is configured so as to cause a display device 28 to display each of various screens including the various pieces of information input from the terminal-side invitation controller 40. In FIGS. 11 and 13, an illustration of a connecting line between the terminal-side invitation controller 40 and the output controller 37 is omitted.

The server-side invitation control unit 41 is constituted by the invitation-checking request receiver 44, the invitation information checking unit 45, the checking result transmitter 46, the acceptance-operation request receiver 50, the vehicle-group-ID registration unit 51, the invitation-operation request receiver 54, and the invitation-information registration unit 55.

Because the hardware configurations of each terminal apparatus 39, the first server device 2, and the second server device 3 according to Embodiment 2 are the same as those according to Embodiment 1, descriptions will be made using FIG. 4. The functions of the invitation-checking request generator 42, the acceptance-operation request generator 48, and the invitation-operation request generator 52 which are shown in FIG. 13 are implemented by a processor 70 that reads and executes a program stored in a first memory 71 shown in FIG. 4. The invitation-checking request transmitter 43, the acceptance-operation request transmitter 49, and the invitation-operation request transmitter 53 which are shown in FIG. 13 are implemented by a transmitter 74 shown in FIG. 4. The checking result receiver 47 shown in FIG. 13 is implemented by a receiver 75 shown in FIG. 4.

Further, the functions of the invitation information checking unit 45, the vehicle-group-ID registration unit 51, and the invitation-information registration unit 55 which are shown in FIG. 13 are implemented by a processor 80 that reads and executes a program stored in a first memory 81 shown in FIG. 4. The checking result transmitter 46 shown in FIG. 13 is implemented by a transmitter 84 shown in FIG. 4. The invitation-checking request receiver 44, the acceptance-operation request receiver 50, and the invitation-operation request receiver 54 which are shown in FIG. 13 are implemented by a receiver 85 shown in FIG. 4.

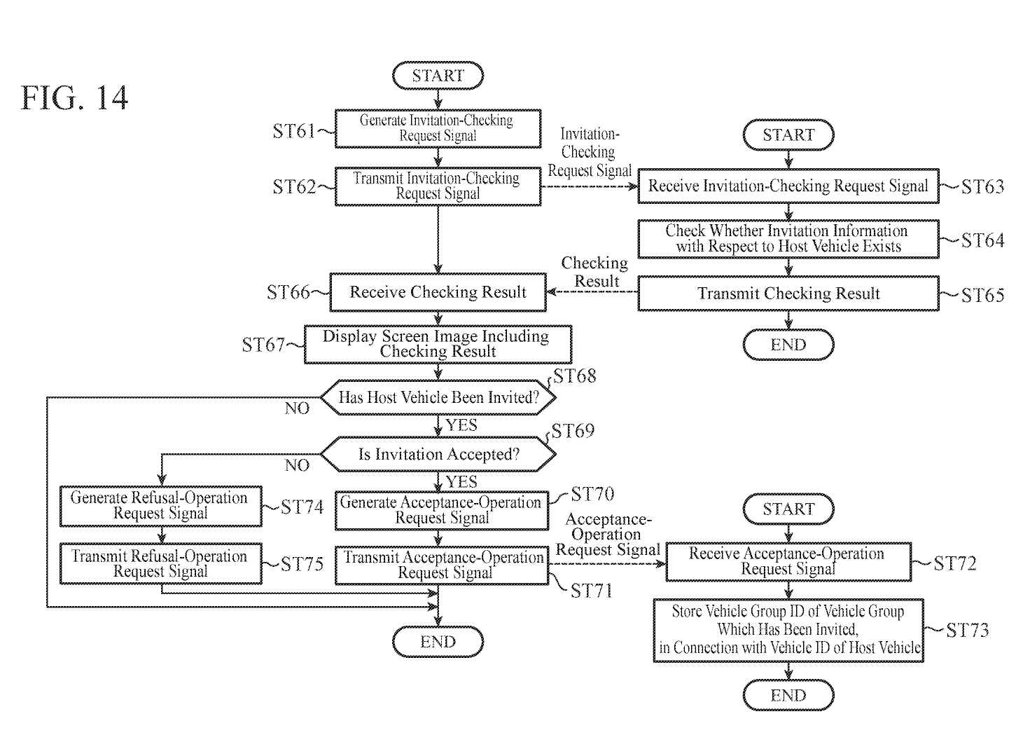

Next, the operations of the terminal apparatus 39 and the first server device 2 will be described with reference to a flowchart of FIG. 14, focusing on the operations of the output controller 37, the invitation-checking request generator 42, the invitation-checking request transmitter 43, the invitation-checking request receiver 44, the invitation information checking unit 45, the checking result transmitter 46, the checking result receiver 47, the acceptance-operation request generator 48, the acceptance-operation request transmitter 49, the acceptance-operation request receiver 50, and the vehicle-group-ID registration unit 51. The terminal apparatus 39 starts a process of step ST61 when the power supply of the terminal apparatus 39 is switched on.

First, in step ST61, the invitation-checking request generator 42 generates an invitation-checking request signal. The vehicle ID of the host vehicle 1 is included in the invitation-checking request signal. The invitation-checking request generator 42 outputs the generated invitation-checking request signal to the invitation-checking request transmitter 43.

Then, in step ST62, the invitation-checking request transmitter 43 transmits the invitation-checking request signal input in step ST61 from the invitation-checking request generator 42. Then, in step ST63, the invitation-checking request receiver 44 of the first server device 2 receives the invitation-checking request signal which the invitation-checking request transmitter 43 transmits in step ST62, and outputs the invitation-checking request signal to the invitation information checking unit 45.

Then, in step ST64, the invitation information checking unit 45 checks whether or not information about an invitation for the host vehicle 1 is stored in the user information database 16 by using the vehicle ID of the host vehicle 1 indicated by the invitation-checking request signal. The invitation information checking unit 45 outputs a result of the check to the checking result transmitter 46.

At this time, when information about an invitation for the host vehicle 1 is stored in the user information database 16, the vehicle ID of another vehicle which has invited the host vehicle 1 is included in the checking result. On the other hand, when no information about an invitation for the host vehicle 1 is stored in the user information database 16, the checking result shows that no invitation information is stored.

Then, in step ST65, the checking result transmitter 46 transmits the checking result input in step ST64 from the invitation information checking unit 45. After step ST65, the first server device 2 temporarily ends the processing.

Then, in step ST66, the checking result receiver 47 of the terminal apparatus 39 receives the checking result which the checking result transmitter 46 transmits in step ST65. The checking result receiver 47 outputs the checking result to the acceptance-operation request generator 48.

Then, in step ST67, the output controller 37 causes the display device 28 to display a screen image including the checking result which the checking result receiver 47 receives in step ST66. This screen image is the one showing that when no information about an invitation for the host vehicle 1 is stored in the user information database 16, no invitation information is stored. On the other hand, when information about an invitation for the host vehicle 1 is stored in the user information database 16, the screen image is the one which shows the vehicle ID of another vehicle which has invited the host vehicle 1, and which also prompts a selection of whether or not to accept the invitation provided from another vehicle.

Then, in step ST68, the acceptance-operation request generator 48 makes a determination using the checking result input in step ST66 from the checking-result receiver 47, as to whether or not the host vehicle 1 has been invited to a vehicle group. When the host vehicle 1 has been invited to a vehicle group (“YES” in step ST68), the acceptance-operation request generator 48, in step ST69, determines which one of a manipulation's input indicating the acceptance of the invitation and a manipulation's input indicating the refusal of the invitation is received through the screen image displayed in step ST67 by the manual input device 23.

When the manual input device 23 receives the manipulation's input indicating the acceptance of the invitation (“YES” in step ST69), the acceptance-operation request generator 48, in step ST70, generates an acceptance-operation request signal. In the acceptance-operation request signal, the vehicle ID of the host vehicle 1 and the vehicle ID of another vehicle indicated by the checking result are included. The acceptance-operation request generator 48 outputs the generated acceptance-operation request signal to the acceptance-operation request transmitter 49.

Then, in step ST71, the acceptance-operation request transmitter 49 transmits the acceptance-operation request signal input in step ST70 from the acceptance-operation request generator 48. Then, in step ST72, the acceptance-operation request receiver 50 of the first server device 2 receives the acceptance-operation request signal which the acceptance-operation request transmitter 49 transmits in step ST71. The acceptance-operation request receiver 50 outputs the generated acceptance-operation request signal to the vehicle-group-ID registration unit 51.

Then, in step ST73, the vehicle-group-ID registration unit 51 stores the vehicle group ID of the vehicle group including another vehicle indicated by the acceptance-operation request signal while associating the vehicle group ID with the vehicle ID of the host vehicle 1 in the user information database 16.

On the other hand, when the manual input device 23 receives the manipulation's input indicating the refusal of the invitation (“NO” in step ST69), the acceptance-operation request generator 48, in step ST74, generates a refusal-operation request signal. In the refusal-operation request signal, the vehicle ID of the host vehicle 1 and the vehicle ID of another vehicle indicated by the checking result are included. The acceptance-operation request generator 48 outputs the generated refusal-operation request signal to the acceptance-operation request transmitter 49.

Then, in step ST75, the acceptance-operation request transmitter 49 transmits the refusal-operation request signal which the acceptance-operation request generator 48 generates in step ST74.

Then, the acceptance-operation request receiver 50 of the first server device 2 receives the refusal-operation request signal transmitted by the acceptance-operation request transmitter 49, and outputs the refusal-operation request signal to the vehicle-group-ID registration unit 51. Then, the vehicle-group-ID registration unit 51 deletes the information about the invitation which is provided for the host vehicle 1 by another vehicle, the invitation information being indicated by the refusal-operation request signal, from the user information database 16. In FIG. 14, an illustration of these processes is omitted.

When receiving the acceptance-operation request signal from the terminal apparatus 39 of the host vehicle 1, the first server device 2 can provide the terminal apparatus 39 of another vehicle with a push notification showing that the host vehicle 1 has accepted the invitation, whereas when receiving the refusal-operation request signal from the terminal apparatus 39 of the host vehicle 1, the first server device can provide the terminal apparatus 39 of another vehicle with a push notification showing that the host vehicle 1 has refused the invitation. The terminal apparatus 39 of another vehicle causes the display device 28 of another vehicle to display a screen image showing that the host vehicle 1 has accepted or refused the invitation.

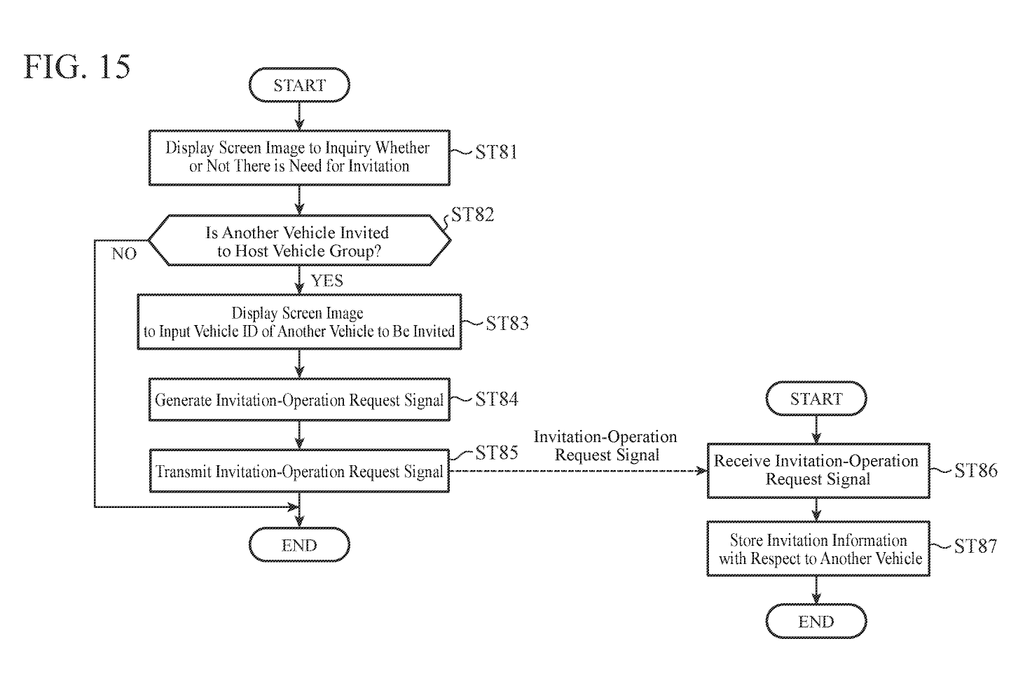

Next, the operations of the terminal apparatus 39 and the first server device 2 will be described with reference to a flowchart of FIG. 15, focusing on the operations of the output controller 37, the invitation-operation request generator 52, the invitation-operation request transmitter 53, the invitation-operation request receiver 54, and the invitation-information registration unit 55. When, for example, a determination result showing NO is provided in step ST68 of FIG. 14 or in step ST69 of FIG. 14, the terminal apparatus 39 then starts a process of step ST81.

First, in step ST81, the output controller 37 causes the display device 28 to display a screen image that prompts a selection of whether or not to invite another vehicle to the host vehicle group.

Then, in step ST82, the output controller 37 determines which one of a manipulation's input indicating the invitation of another vehicle to the host vehicle group and a manipulation's input indicating no invitation is received through the screen image displayed in step ST81 by the manual input device 23. When the manual input device 23 receives the manipulation's input indicating the invitation of another vehicle to the host vehicle group (“YES” in step ST82), the output controller 37, in step ST83, causes the display device 28 to display a screen image for input of the vehicle ID of another vehicle to be invited to the host vehicle group.

A user inputs the vehicle ID of another vehicle to the input screen image displayed in step ST83. The input vehicle ID of another vehicle can be alternatively provided by a system configuration that can freely perform a search on the first server device 2 by a manipulation on the manual input device 23, or can be exchanged, via communications between users, outside the system.

Then, in step ST84, the invitation-operation request generator 52 acquires the vehicle ID of another vehicle input to the input screen image displayed in step ST83. The invitation-operation request generator 52 generates an invitation-operation request signal including the vehicle ID of the host vehicle 1 and the input vehicle ID of another vehicle.

The invitation-operation request generator 52 outputs the generated invitation-operation request signal to the invitation-operation request transmitter 53.

Then, in step ST85, the invitation-operation request transmitter 53 transmits the invitation-operation request signal input in step ST84 from the invitation-operation request generator 52. Then, in step ST86, the invitation-operation request receiver 54 of the second server device 3 receives the invitation-operation request signal which the invitation-operation request transmitter 53 transmits in step ST85. The invitation-operation request receiver 54 outputs the received invitation-operation request signal to the invitation-information registration unit 55.

Then, in step ST87, the invitation-information registration unit 55 causes the user information database 16 to store the information about the invitation which is provided for another vehicle by the host vehicle 1, the invitation information being indicated by the invitation-operation request signal.

When new invitation information is stored in the user information database 16, the first server device 2 can provide the terminal apparatus 39 of the invited vehicle with a push notification showing that the new invitation information is stored. The terminal apparatus 39 of the invited vehicle causes the display device 28 to display a screen image showing that the new invitation information is stored in the user information database 16.

Because the operations of the image recognition processor 11, the occupant-information request generator 12, and an occupant-information request transmitter 13 of the terminal apparatus 39 are the same as those according to Embodiment 1, the operations will be described using FIG. 5. In step ST5, the occupant-information request generator 12 generates an occupant-information request signal including the vehicle ID of the host vehicle 1 and the driver information about the host vehicle in addition to the results of the image recognition processing performed by the image recognition processor 11.

Because the operations of the first server device 2 is the same as those according to Embodiment 1, the operations will be described using FIG. 6. In step ST16, the occupant-information acquisition unit 15 assigns a new user ID to a face image indicated by each result of the image recognition processing, and stores the face image, the user ID of the user, the vehicle ID of the host vehicle, and the driver information in the user information database 16 while associating the face image, the user ID, the vehicle ID, and the driver information with one another.

In between steps ST17 and ST18, when the vehicle group ID of the vehicle group including the vehicle ID indicated by the occupant-information request signal, namely, the vehicle group ID of the host vehicle group is stored in the user information database 16, the occupant-information acquisition unit 15 acquires the vehicle ID of another vehicle included in the host vehicle group, the face image and the user ID of each user who is in another vehicle and the user information about the user, and the driver information about another vehicle from the user information database 16, and outputs the vehicle ID, the face image, the user ID, the user information, and the driver information to the occupant-information transmitter 17.

In step ST18, the occupant-information transmitter 17 transmits the various pieces of information input from the occupant-information acquisition unit 15.

Because the operations of a route setting unit 24, the facility-search request generator 30, a facility-search request transmitter 31, and the output controller 37 of the terminal apparatus 39 are the same as those according to Embodiment 1, the operations will be described using FIG. 7. In step ST25, the facility-search request generator 30 generates a facility-search request signal including a key word, the positional information about a search point, the one or more pieces of user information, the one or more pieces of driver information, and the one or more vehicle IDs which are stored in the occupant-information storage 19.

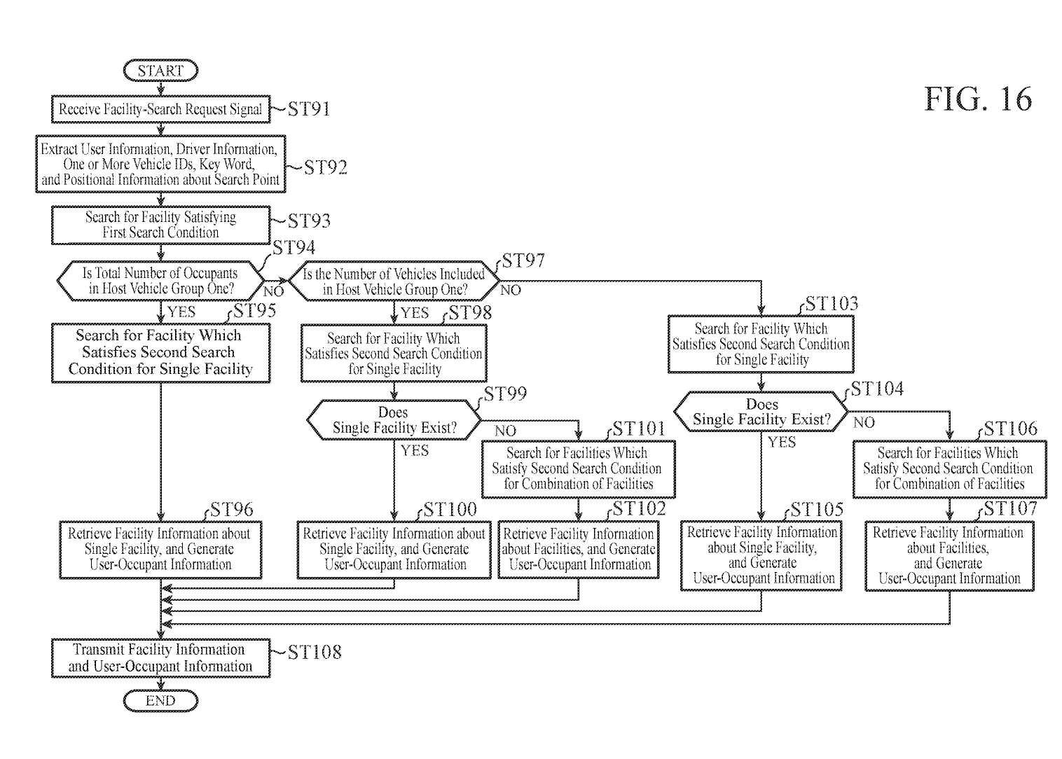

Next, the operations of the second server device 3 will be described with reference to a flowchart of FIG. 16.

First, in step ST91, the facility-search request receiver 32 receives the facility-search request signal which the facility-search request transmitter 31 transmits in step ST26 of FIG. 7. The facility-search request receiver 32 outputs the received facility-search request signal to the facility-search unit 33.

Then, in step ST92, the facility-search unit 33 extracts the one or more pieces of user information, the one or more pieces of driver information, the one or more vehicle IDs, the key word, and the positional information about the search point which are included in the facility-search request signal input in step ST91 from the facility-search request receiver 32.

Then, in step ST93, the facility-search unit 33 sets up a first search condition, and searches through the facilities whose pieces of facility information are stored in the facility information database 34, for a facility satisfying the first search condition. Because a concrete example of the first search condition is the same as that of the first search condition in step ST33 shown in FIG. 8, an explanation of the concrete example will be omitted hereafter.

Then, in step ST94, the facility-search unit 33 determines whether or not the total number of occupants of the host vehicle group is one. More specifically, when only the user information about one person is included in the facility-search request signal, the facility-search unit 33 determines that the total number of occupants is one, whereas when the pieces of user information about two or more persons are included, the facility-search unit determines that the total number of occupants is two or more.

The case in which the total number of occupants of the host vehicle group is one (the case of “YES” in step ST94) just means a state in which only the host vehicle 1 constitutes the host vehicle group and only one occupant (driver) is in the host vehicle 1. In this case, the facility-search unit 33 performs processes in steps ST95 and ST96 which are the same as those in steps ST35 and ST36 which are shown in FIG. 8. Because a concrete example of a second search condition in step ST95 is the same as that of the second search condition in step ST35 shown in FIG. 8, an explanation of the concrete example will be omitted hereafter.

On the other hand, when the total number of occupants of the host vehicle group is two or more (“NO” in step ST94), the facility-search unit 33, in step ST97, determines whether or not the number of vehicles included in the host vehicle group is one. More specifically, when only the vehicle ID of one vehicle is included in the facility-search request signal, the facility-search unit 33 determines that the number of vehicles is one, whereas when the vehicle IDs of two or more vehicles are included in the facility-search request signal, the facility-search unit determines that the number of vehicles is two or more.

The case in which the number of vehicles included in the host vehicle group is one (the case of “NO” in step ST94 and “YES” in step ST97) just means a state in which only the host vehicle 1 constitutes the host vehicle group and two or more occupants are in the host vehicle 1. In this case, the facility-search unit 33 performs processes in steps ST98 to ST102 which are the same as those in steps ST37 to ST41 shown in FIG. 8. Because a concrete example of the second search condition in steps ST98 and ST101 is the same as that of the second search condition in steps ST37 and ST40 which are shown in FIG. 8, an explanation of the concrete example will be omitted hereafter.

On the other hand, when the number of vehicles included in the host vehicle group is two or more (“NO” in step ST94 and “NO” in step ST97), the facility-search unit 33, in step ST103, sets up a second search condition and searches through the facilities included in a search result acquired in step ST93, for a facility which satisfies the second search condition for a single facility. The second search condition in step ST103 include, for example, all of the following conditions (1) to (3):

(1) The category of the facility matches a preference of an occupant who uses the facility.

(2) The facility has at least vacant seats or rooms whose number is equal to the number of occupants of the host vehicle group.

(3) The facility has a parking lot, and the parking lot has at least vacant spaces whose number is equal to the number of vehicles included in the host vehicle group.

Then, in step ST104, the facility-search unit 33 determines whether there exists a facility which satisfies the second search condition for a single facility, on the basis of a result of the search process in step ST103.

When there exists a facility which satisfies the second search condition for a single facility (“YES” in step ST104), the facility-search unit 33, in step ST105, acquires the facility information about a facility included in the search result acquired in step ST103, namely, a facility which satisfies the second search condition for a single facility, from the facility information database 34. The facility-search unit 33 outputs the acquired facility information to the facility information transmitter 35. The facility-search unit 33 also generates user-occupant information indicating that all the occupants of the host vehicle group should use the single facility, and outputs the user-occupant information to the facility information transmitter 35.

On the other hand, when there does not exist a facility which satisfies the second search condition for a single facility (“NO” in step ST104), the facility-search unit 33, in step ST106, searches through the facilities included in the search result acquired in step ST93, for plural facilities which satisfy the second search condition for a combination of facilities. Here, plural facilities which satisfy the second search condition for a combination of facilities are ones which satisfy the second search condition when each of the vehicles included in the host vehicle group is categorized into one of plural groups or each of the occupants of the host vehicle group is categorized into one of plural groups, and an occupant in each of the plural groups uses a facility different from that which an occupant in any other one of the groups uses. The number of vehicles included in each group can be one or two or more, or the number of occupants included in each group can be one or two or more.

At this time, the facility-search unit 33 makes a combination of plural facilities in such a way that the combination satisfies, for example, all of the following conditions (1) to (4):

(1) An upper limit on the number of facilities to be combined is equal to the number of occupants of the host vehicle group.

(2) At least facilities which the drivers of the vehicles use, among the facilities to be combined, have parking lots, and vacant spaces whose number is equal to the number of vehicles included in the host vehicle group can be ensured by the parking lots.

(3) The distances among the facilities to be combined fall within a predetermined reference range. Concretely, for example, the straight-line distances among the facilities are equal to or shorter than 500 meters, or the distances of routes among the facilities are the ones along each of which the host vehicle 1 can travel in ten minutes or less.

(4) A combination of a smaller number of facilities is made in such a way that the second search condition is satisfied. For example, when there exist only two facilities which satisfy the second search condition for a combination of two facilities, a search for three or more facilities which satisfy the second search condition for a combination of three or more facilities is not performed.

Then, in step ST107, the facility-search unit 33 acquires the facility information about each facility included in a search result acquired in step ST106, namely, each of plural facilities which satisfy the second search condition for a combination of facilities, from the facility information database 34. The facility-search unit 33 outputs the acquired facility information to the facility information transmitter 35. At this time, the facility-search unit 33 outputs pieces of facility information in a form in which the facility information about a facility which only an occupant other than the driver of each of the vehicles should use is made to be subordinate to the facility information about a facility which occupants including the driver of each of the vehicles should use. The facility-search unit 33 also generates user-occupant information indicating an occupant who should use each of the plural facilities and outputs the user-occupant information to the facility information transmitter 35.

Following step ST96, ST100, ST102, ST105, or ST107, the facility information transmitter 35, in step ST108, transmits the one or more pieces of facility information and the one or more pieces of user-occupant information input in step ST96, ST100, ST102, ST105, or ST107 from the facility-search unit 33.

Because the operations of a facility information receiver 36, the route setting unit 24, and the output controller 37 of the terminal apparatus 39 are the same as those described with reference to FIG. 9 in Embodiment 1, an illustration and an explanation of the operations will be omitted hereafter.

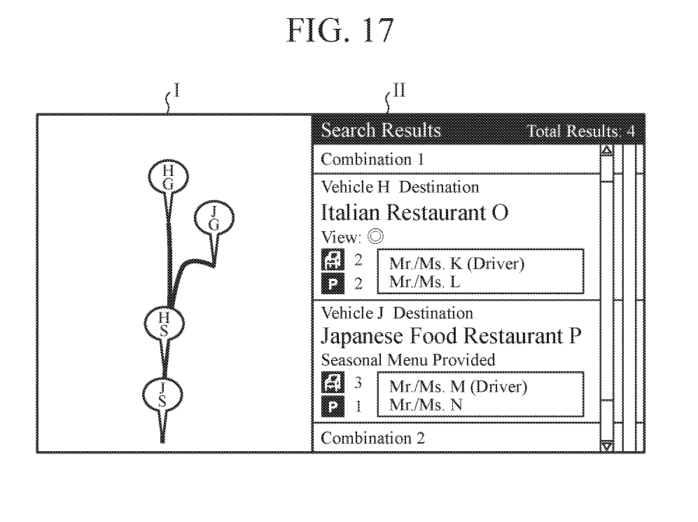

An example of a screen image which the display device 28 displays in step ST52 of FIG. 9 is shown in FIG. 17. FIG. 17 shows an example of a case in which in a state in which two vehicles H and J are included in the host vehicle group, and a driver K and an occupant L are in the vehicle H and a driver M and an occupant N are in another vehicle J, the two vehicles H and J are respectively divided into two groups each having a single vehicle and a combination of two facilities: “Italian restaurant O” and “Japanese food restaurant P” satisfies the search condition.

As shown in FIG. 17, travel routes which are found by the route setting unit 24 are displayed in a display area I occupying a left half part of the screen. Concretely, a travel route from the current position of the vehicle H to “Italian restaurant O” which is the facility which the occupants (the driver K and the occupant L) in the vehicle H should use, and a travel route from the current position of the vehicle J to “Japanese food restaurant P” which is the facility which the occupants (the driver M and the occupant N) in the vehicle J should use are displayed. In this way, guidance on the travel routes in which an appropriate destination is set up for each of the vehicles can be provided.

It is assumed that when searching for travel routes as illustrated in FIG. 17, the terminal apparatuses 39 of the vehicles included in the host vehicle group share the pieces of information indicating the current positions of the vehicles by using the first server device 2 or the like.

Further, in a display area II occupying a right half part of the screen, the facility information about “Italian restaurant O”, which is the destination of the vehicle H, and the user-occupant information, and the facility information about “Japanese food restaurant P”, which is the destination of the vehicle J, and the user-occupant information are displayed. As a concrete example of each of the pieces of facility information, a facility name, a feature, the number of vacant seats, and the number of vacant spaces of an attached parking lot are displayed. As a result, the information about the facility which is set as the destination of each vehicle and the occupants who should use each facility can be informed visually and intelligibly.

The user information database 16 can store pieces of information about each vehicle (e.g., the current position, the remainder of the gasoline, the fuel efficiency, the battery residual quantity, the power consumption, or the like of each vehicle), in addition to the information pieces illustrated as examples in FIGS. 12A, 12B and 12C. The terminal apparatus 39 can receive these pieces of information about each vehicle from the first server device 2, and transmit a facility-search request signal including the pieces of information about each vehicle to the second server device 3. The second search condition can be any type of condition as long as the second search condition can be set up using the pieces of information included in the facility-search request signal, and is not limited to the above-mentioned example.

Further, a map database 25 and a navigation function unit 27 can be disposed in, instead of the terminal apparatus 39, either the second server device 3 or a not-illustrated fourth server device.

As mentioned above, in the facility-information guidance device 38 according to Embodiment 2, the facility-search request transmitter 31 transmits a facility-search request signal including, in addition to information about an occupant of a vehicle (vehicle included in the host vehicle group), information about the vehicle (vehicle included in the host vehicle group) to the server device (second server device 3). As a result, the second server device 3 can set up a search condition which is based on the information about the vehicle, such as the number of vehicles included in the host vehicle group.

Further, the plural facilities are the ones which satisfy the search condition when each vehicle (vehicle included in the host vehicle group) or each occupant of each vehicle (occupant of the host vehicle group) is categorized into one of plural groups, and an occupant in each of the plural groups uses a facility different from that which an occupant in any other one of the groups uses. As a result, even when there does not exist a facility which satisfies the second search condition for a single facility because not only the condition about the number of persons who can use a facility with respect to the number of occupants of the one or more vehicles, namely, the condition (2) of the second search condition, but also the condition about the number of vehicles which can be parked in the facility with respect to the number of vehicles, namely, the condition (3) of the second search condition is not satisfied, guidance on pieces of information about appropriate facilities satisfying the search condition can be provided.

### Embodiment 3

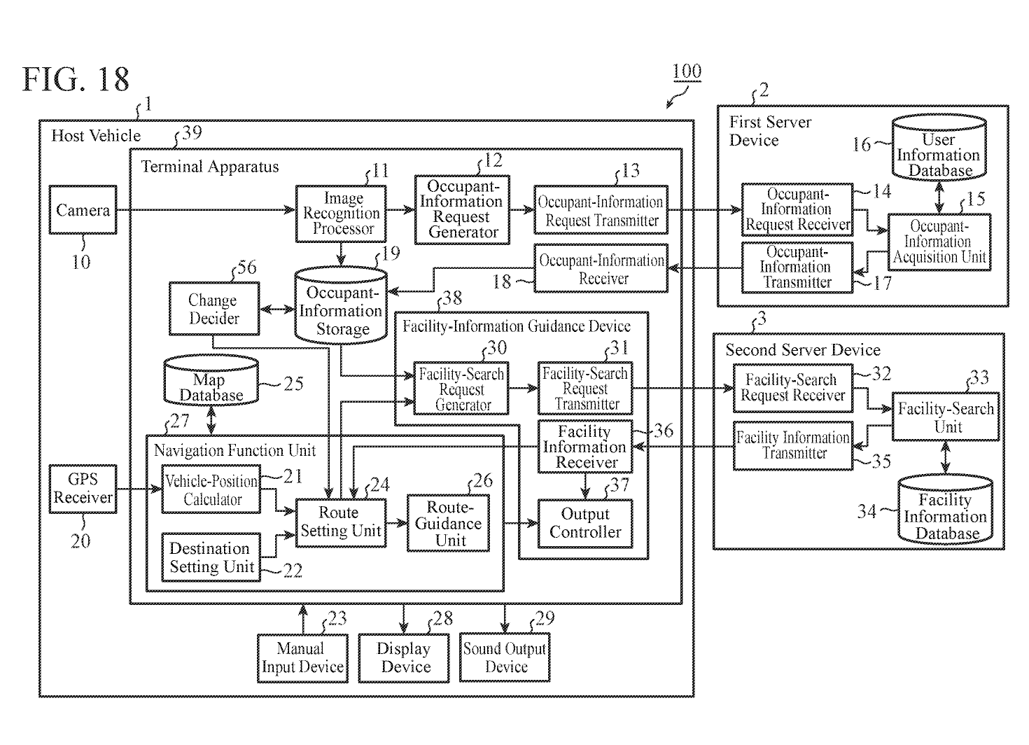

FIG. 18 is a functional block diagram showing a main part of a facility-information guidance system according to Embodiment 3 of the present invention. The facility-information guidance system 100 according to Embodiment 3 will be described with reference to FIG. 18. In FIG. 18, the same blocks as those of the facility-information guidance system 100 according to Embodiment 1 shown in FIG. 1 are denoted by the same reference numerals, and an explanation of the blocks will be omitted hereafter.

After starting guidance on a navigation route, the guidance being based on one or more pieces of facility information received from a second server device 3, a terminal apparatus 39 repeatedly performs a process of generating an occupant-information request signal and transmitting this occupant-information request signal to a first server device 2 (steps ST2 to ST6 of FIG. 5), and a process of causing an occupant-information storage 19 to store one or more user IDs and one or more pieces of user information which are received from the first server device 2, at predetermined time intervals, e.g., every thirty seconds. At this time, when another user ID other than the one or more user IDs received from the first server device 2 is already stored in the occupant-information storage 19, the other user ID, and a face image, user information, driver information, and so on which are associated with the other user ID are deleted. On the other hand, when the same user ID as a user ID received from the first server device 2 is already stored in the occupant-information storage 19, the user information associated with the user ID is overwritten.

In the facility-information guidance system 100 according to Embodiment 3, the terminal apparatus 39 has a change decider 56. The change decider 56 monitors the occupant-information storage 19, to decide whether a change occurs in information stored in the occupant-information storage 19. Further, when a change occurs in information stored in the occupant-information storage 19, the change decider 56 compares the information before the change with that after the change, to decide whether the change is caused by only an occupant's getting out of the vehicle, an occupant's getting in the vehicle, or replacement accompanied by an occupant's getting in and out of the vehicle. The change decider 56 notifies a route setting unit 24 of a result of the decision.

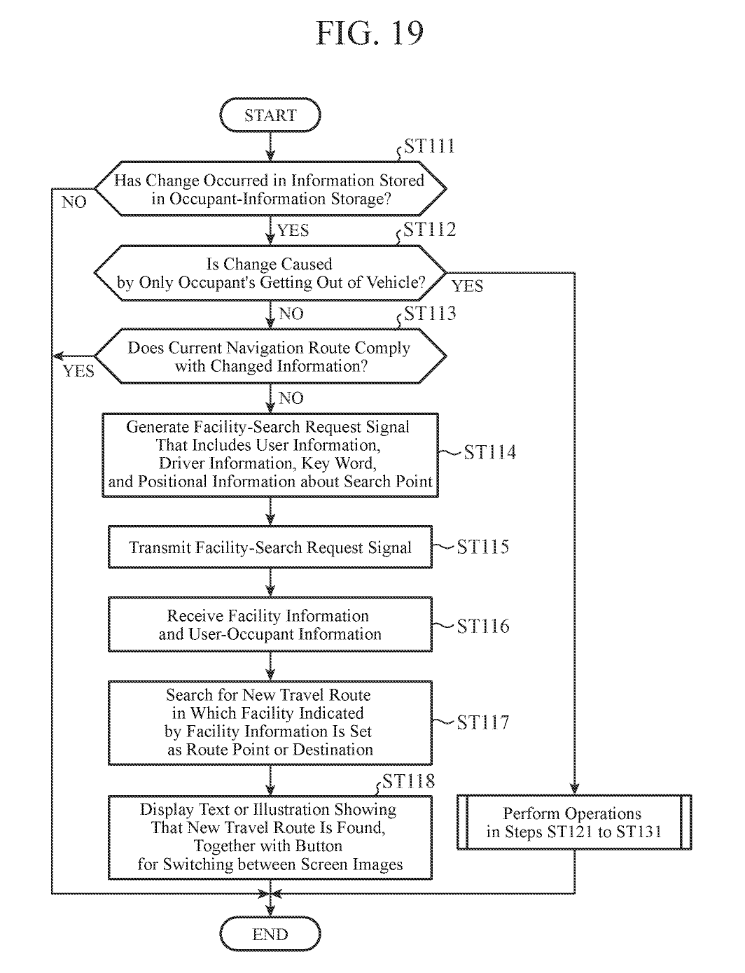

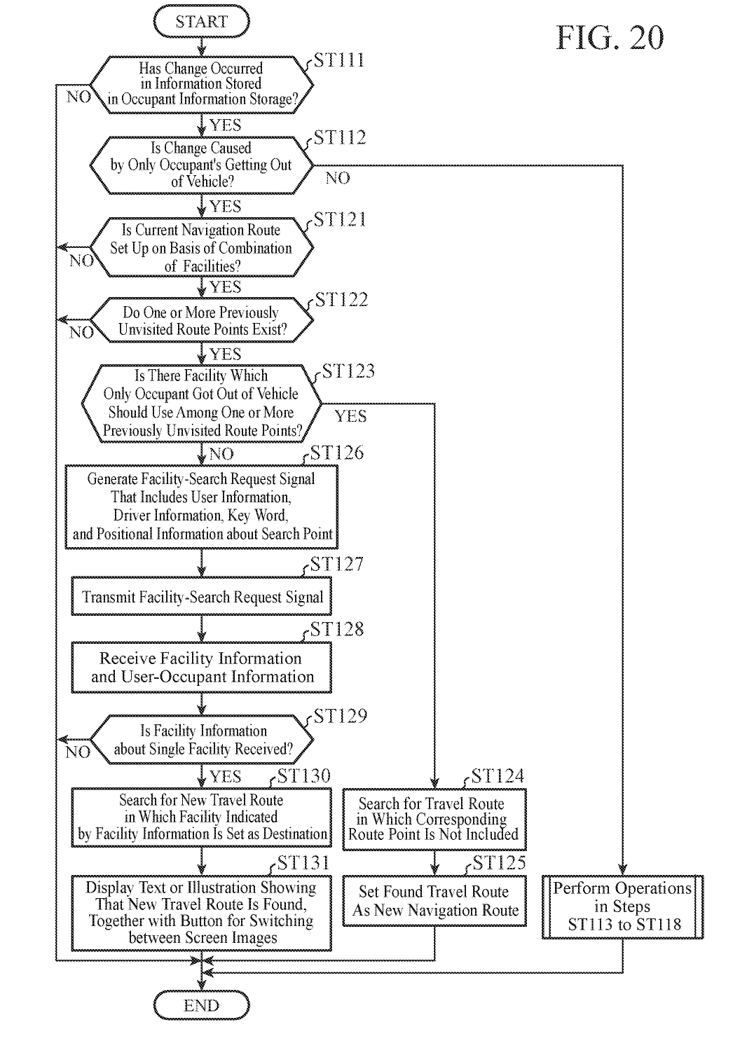

The route setting unit 24 performs a process of searching for a new travel route different from a current navigation route, or the like in accordance with the decision result provided by the change decider 56. The details of the process performed by the route setting unit 24 will be mentioned later by reference to FIGS. 19 and 20.

Next, the operations of the terminal apparatus 39 will be described with reference to flowcharts shown in FIGS. 19 and 20, focusing on the operations of the route setting unit 24, a facility-search request generator 30, a facility-search request transmitter 31, a facility information receiver 36, an output controller 37, and the change decider 56. In an initial state, a route-guidance unit 26 performs guidance on a navigation route, the guidance being based on facility information received from the second server device 3. Every time an occupant-information receiver 18 performs a process of causing the occupant-information storage 19 to store a user ID and user information which are received from the first server device 2 to store, the change decider 56 starts an operation in step ST111.

First, in step ST111, the change decider 56 decides whether a change occurs in information stored in the occupant-information storage 19. When a change occurs in information stored in the occupant-information storage 19 (“YES” in step ST111), the change decider 56, in step ST112, compares the information before the change with that after the change, to decide whether or not the change is caused by only an occupant's getting out of the vehicle.

When the change in the information stored in the occupant-information storage 19 is not caused by only an occupant's getting out of the vehicle, namely, when the change is caused by an occupant's getting in the vehicle, or replacement accompanied by an occupant's getting in and out of the vehicle (“NO” in step ST112), the change decider 56 provides a notification to that effect for the route setting unit 24.

The route setting unit 24 which receives the notification from the change decider 56, in step ST113, decides whether the current navigation route complies with a new occupant who has simply got in the vehicle or has got in the vehicle because of replacement. Concretely, for example, the route setting unit 24 determines whether the category of a route point or destination included in the current navigation route matches the new occupant's preference. The route setting unit 24 can perform this operation by acquiring the one or more pieces of user information about one or more occupants after the change, the one or more pieces of user information being stored in the occupant-information storage 19, and compares the one or more pieces of user information with the facility information about each facility which is set as a route point or destination included in the current navigation route. In FIG. 18, an illustration of a connecting line between the route setting unit 24 and the occupant-information storage 19 is omitted. When the current navigation route does not comply with the new occupant, the route setting unit 24 provides a notification to that effect for the facility-search request generator 30.

The facility-search request generator 30 which receives the notification from the route setting unit 24, in step ST114, generates a facility-search request signal. In this facility-search request signal, the one or more pieces of user information and the driver information after the change which are stored in the occupant-information storage 19 are included. Further, in this facility-search request signal, the same key word as a key word used for a search for a facility which is set as a route point or destination in the current navigation route and positional information indicating the same search point as a search point used for the search are included.

Then, in step ST115, the facility-search request transmitter 31 transmits the facility-search request signal which the facility-search request generator 30 generates in step ST114. After step ST115, the second server device 3 performs the same operations as those described with reference to FIG. 8 in Embodiment 1.

Then, in step ST116, the facility information receiver 36 receives one or more pieces of facility information transmitted by the second server device 3, and outputs the one or more pieces of facility information to the route setting unit 24.

Then, in step ST117, the route setting unit 24 searches for a new travel route in which a facility indicated by each facility information input in step ST116 from the facility information receiver 36 is set as a route point or destination.

Then, in step ST118, the output controller 37 causes a display device 28 to display both a text or illustration showing that the new travel route is found and a button for switching between screens while superimposing the text or illustration and the button on a screen image for providing guidance on the current navigation route.

When the button is pushed down by a manipulation on a manual input device 23, the output controller 37 causes the display device 28 to display a screen image including the new travel route found by the route setting unit 24, the pieces of facility information about a route point and a destination in the new travel route, and the pieces of user-occupant information. Because this screen image is the same as that illustrated in FIG. 10, an illustration and an explanation of the screen image will be omitted hereafter.

On the other hand, when a change occurs in information stored in the occupant-information storage 19 and this change is caused by only an occupant's getting out of the vehicle (“YES” in step ST111 and “YES” in step ST112), the change decider 56 provides a notification to that effect for the route setting unit 24.

The route setting unit 24 which receives the notification from the change decider 56, in step ST121, determines whether or not the current navigation route is the one in which each of plural facilities which satisfy a search condition for a combination of facilities is set as a route point or destination. When the current navigation route is the one which is based on a combination of plural facilities (“YES” in step ST121), the route setting unit 24, in step ST122, determines whether there exists a route point which has not been visited.

When the current navigation route is the one in which a facility which satisfies the search condition for a single facility is set as a destination (“NO” in step ST121), there is a high probability that the destination is a facility which matches a preference or the like of an occupant who has remained in the vehicle without getting out of the vehicle. Further, when all the route points have been visited even though the current navigation route is the one in which each of plural facilities which satisfy the search condition for a combination of facilities is set as a route point or destination (“YES” in step ST121 and “NO” in step ST122), there is a high probability that the destination is a facility which matches a preference or the like of an occupant who has remained in the vehicle without getting out of the vehicle. In these cases, the terminal apparatus 39 does not perform operations in next step ST123 and subsequent steps, and the route-guidance unit 26 continues the operation of providing guidance on the current navigation route. As a result, the processing load on the terminal apparatus 39 can be reduced.

On the other hand, when there exists a route point which has not been visited (“YES” in step ST122), the route setting unit 24, in step ST123, determines whether, among route points which have not been visited, there exists a facility which only an occupant who has got out of the vehicle should use. Concretely, the route setting unit 24 acquires the difference between the one or more pieces of user information before the change and the one or more pieces of user information after the change from the change decider 56, to identify the occupant who has got out of the vehicle. The route setting unit 24 determines whether the user-occupant information about each route point which has not been visited shows only the identified occupant.

When there exists a facility which only the occupant who has got out of the vehicle should use (“YES” in step ST123), the route setting unit 24, in step ST124, searches for a travel route in which the facility is not included in the route points. Then, in step ST125, the route setting unit 24 sets, as a new navigation route, the travel route which the route setting unit finds in step ST124.

On the other hand, when among the route points which the vehicle has not visited, there does not exist a facility which only the occupant who has got out of the vehicle should use (“NO” in step ST123), the route setting unit 24 provides a notification to that effect for the facility-search request generator 30.

The facility-search request generator 30 which receives the notification from the route setting unit 24, in step ST126, generates a facility-search request signal. In this facility-search request signal, the one or more pieces of user information and the driver information after the change which are stored in the occupant-information storage 19 are included. Further, in this facility-search request signal, the same key word as a key word used for a search for a facility which is set as a route point or destination in the current navigation route and positional information indicating the same search point as a search point used for the search are included.

Then, in step ST127, the facility-search request transmitter 31 transmits the facility-search request signal which the facility-search request generator 30 generates in step ST126. After step ST127, the second server device 3 performs the same operations as those described with reference to FIG. 8 in Embodiment 1.

Then, in step ST128, the facility information receiver 36 receives one or more pieces of facility information transmitted by the second server device 3 and outputs the one or more pieces of facility information to the route setting unit 24.

Then, in step ST129, the route setting unit 24 determines whether the facility information input in step ST127 from the facility information receiver 36 represents information about a single facility, namely, information about a facility which satisfies a search condition for a single facility.

When the facility information about facilities which satisfy a search condition for plural facilities is input (“NO” in step ST129), even if a search for a travel route is made using the facility information, a found travel route passes through one or more route points in the result, like the current navigation route. In this case, from the aspect of reducing the processing load on the terminal apparatus 39 and also reducing repetition of user's manipulations while driving, the terminal apparatus 39 does not perform operations in next step ST130 and subsequent steps, and the route-guidance unit 26 continues to provide guidance concerning the current navigation route.

On the other hand, when the facility information about a facility which satisfies the search condition for a single facility is input (“YES” in step ST129), a search for a travel route using the facility information is made, and thereby the travel route directly leading to a destination is possibly found as being different from the current navigation route, thus allowing for shortening of the travel distance and travel time of the host vehicle 1 with high probability. In this case, in step ST130, the route setting unit 24 then searches for a new travel route in which the facility indicated by the facility information is set as a destination, by using the facility information input in step ST128 from the facility information receiver 36.

Then, in step ST131, the output controller 37 causes the display device 28 to display both a text or illustration showing that the new travel route is found and a button for switching between screens while superimposing the text or illustration and the button on a screen image for providing guidance on the current navigation route.

When the button is pushed down by a manipulation on the manual input device 23, the output controller 37 causes the display device 28 to display a screen image including the new travel route, the facility information about the destination in the new travel route, and the user-occupant information. Because this screen image is the same as that illustrated in FIG. 10, an illustration and an explanation of the screen image will be omitted hereafter.

As mentioned above, in the facility-information guidance device 38 according to Embodiment 3, when a change occurs in information about an occupant of the vehicle (host vehicle 1), the facility-search request transmitter 31 performs an operation to transmit a facility-search request signal including the information after the change to the server device (second server device 3), and the facility information receiver 36 performs an operation to receive facility information about a facility satisfying a search condition from the server device (second server device 3), the search condition being set up using the information after the change. As a result, for example, when an occupant of the host vehicle 1 has got out of the vehicle or got in the vehicle, or replacement of an occupant by another occupant has occurred, a travel route including a route point or destination corresponding to a new occupant can be found.

The facility-information guidance system 100 according to Embodiment 2 shown in FIG. 11 can have a system configuration in which a change decider 56 which is the same as that according to Embodiment 3 is disposed in the terminal apparatus 39. In this case, in the facility-information guidance device 38, when a change occurs in either information about a vehicle (vehicle included in the host vehicle group) or information about an occupant of a vehicle (vehicle included in the host vehicle group), the facility-search request transmitter 31 performs an operation to transmit a facility-search request signal including the information after the change to the server device (second server device 3), and the facility information receiver 36 performs an operation to receive facility information about a facility satisfying a search condition from the server device (second server device 3), the search condition being set up using the information after the change.

While the invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

### INDUSTRIAL APPLICABILITY

The present invention can be used for a car navigation system and so on.

### REFERENCE SIGNS LIST

1: host vehicle; 2: first server device; 3: second server device; 4: base station; 5: Internet; 6: router; 7: router; 10: camera; 11: image recognition processor; 12: occupant-information request generator; 13: occupant-information request transmitter; 14: occupant-information request receiver; 15: occupant-information acquisition unit; 16: user information database; 17: occupant-information transmitter; 18: occupant-information receiver; 19: occupant-information storage; 20: GPS receiver; 21: vehicle-position calculator; 22: destination setting unit; 23: manual input device; 24: route setting unit; 25: map database; 26: route-guidance unit; 27: navigation function unit; 28: display device; 29: sound output device; 30: facility-search request generator; 31: facility-search request transmitter; 32: facility-search request receiver; 33: facility-search unit; 34: facility information database; 35: facility information transmitter; 36: facility information receiver; 37: output controller; 38: facility-information guidance device; 39: terminal apparatus; 40: terminal-side invitation controller; 41: server-side invitation control unit; 42: invitation-checking request generator; 43: invitation-checking request transmitter; 44: invitation-checking request receiver; 45: invitation information checking unit; 46: checking result transmitter; 47: checking result receiver; 48: acceptance-operation request generator; 49: acceptance-operation request transmitter; 50: acceptance-operation request receiver; 51: vehicle-group-ID registration unit; 52: invitation-operation request generator; 53: invitation-operation request transmitter; 54: invitation-operation request receiver; 55: invitation-information registration unit; 56: change decider; 70: processor; 71: first memory; 72: second memory; 73: third memory; 74: transmitter; 75: receiver; 80: processor; 81: first memory; 82: second memory; 83: third memory; 84: transmitter; 85: receiver; 90: processor; 91: first memory; 92: second memory; 93: third memory; 94: transmitter; 95: receiver; and 100: facility-information guidance system.

1. A facility-information guidance device comprising:
a facility-search request transmitter to transmit to a server device a facility-search request signal including information about one or more occupants of one or more vehicles;
a facility information receiver to receive, from the server device, facility information about a facility satisfying a search condition that is set up using the information included in the facility-search request signal; and
an output controller to perform either a control operation to cause a display device to display a screen image including the facility information, or a control operation to cause a sound output device to output a sound including the facility information, wherein:
when a facility which satisfies the search condition for a single facility exists, the facility information receiver receives the facility information about the single facility from the server device; and
when a facility which satisfies the search condition for a single facility does not exist and facilities which satisfy the search condition for a combination of plural facilities, the facility information receiver receives the facility information about the plural facilities from the server device.

2. The facility-information guidance device according to claim 1, wherein the plural facilities satisfy the search condition when occupants of the one or more vehicles are categorized into plural groups, and occupants use a different facility for each of the plural groups.

3. The facility-information guidance device according to claim 2, wherein:
the facility-search request signal indicates a number of occupants of the vehicle; and
the search condition includes a condition about a number of persons to which use of a facility is available with respect to the indicated number of occupants of the vehicle.

4. The facility-information guidance device according to claim 2, wherein the output controller sets, as a destination, a facility which is used by a driver of the vehicle among the plural facilities, and causes the display device to display a screen image including a travel route in which a remaining facility is set as a route point.

5. The facility-information guidance device according to claim 2, wherein distances between the plural facilities fall within a reference range.

6. The facility-information guidance device according to claim 1, wherein the facility-search request transmitter transmits to the server device the facility-search request signal including information about the one or more vehicles, in addition to the information about one or more occupants of the one or more vehicles.

7. The facility-information guidance device according to claim 6, wherein the plural facilities satisfy the search condition when either the one or more vehicles or occupants of the one or more vehicles are categorized into plural groups, and occupants of the one or more vehicles use a different facility for each of the plural groups.

8. The facility-information guidance device according to claim 6, wherein:
the facility-search request signal indicates a number of the one or more vehicles; and
the search condition includes a condition about a number of vehicles to which parking in a facility is available with respect to the indicated number of the one or more vehicles.

9. The facility-information guidance device according to claim 6, wherein:
the facility-search request signal indicates a number of occupants of the vehicle; and
the search condition includes a condition about a number of persons which use of a facility is available with respect to the indicated number of occupants of the vehicle.

10. The facility-information guidance device according to claim 6, wherein:
the facility-search request signal indicates a number of the one or more vehicles and a number of occupants of the one or more vehicles; and
the search condition includes a condition about a number of vehicles which parking in a facility is available with respect to the indicated number of the one or more vehicles, and includes a condition about a number of persons which use of a facility is available with respect to the indicated number of occupants of the one or more vehicles.

11. The facility-information guidance device according to claim 1, wherein:
when a change occurs in the information about one or more occupants of the one or more vehicles, the facility-search request transmitter performs an operation to transmit the facility-search request signal including the changed information to the server device; and
the facility information receiver performs an operation to receive, from the server device, facility information about a facility satisfying a search condition that is set up using the changed information.

12. A server device comprising:
a facility-search request receiver to receive a facility-search request signal including information about one or more occupants of a vehicle from a terminal apparatus mounted in or carried into the vehicle;
a facility-search unit to set up a search condition using the information included in the facility-search request signal, and to search facilities whose facility information is stored in a facility information database, for a facility satisfying the search condition; and
a facility information transmitter to transmit, to the terminal apparatus, facility information about a facility included in a search result provided by the facility-search unit, wherein:
when a facility which satisfies the search condition for a single facility exists, the facility-search unit includes facility information about the single facility in the search result;
when a facility which satisfies the search condition for a single facility does not exist and facilities which satisfy the search condition for a combination of plural facilities exist, the facility-search unit sets facility information about the plural facilities into the search result.

13. A facility-information guidance method comprising the steps of:
in a facility-search request transmitter, transmitting to a server device a facility-search request signal including information about one or more occupants of one or more vehicles;
in a facility information receiver, receiving, from the server device, facility information about a facility satisfying a search condition that is set up using the information included in the facility-search request signal; and
in an output controller, performing either a control operation to cause a display device to display a screen image including the facility information, or a control operation to cause a sound output device to output a sound including the facility information, wherein:
when a facility which satisfies the search condition for a single facility exists, the facility information receiver receives the facility information about the single facility from the server device; and
when a facility which satisfies the search condition for a single facility does not exist and facilities which satisfy the search condition for a combination of plural facilities exists, the facility information receiver receives the facility information about the plural facilities from the server device.
